(19) United States
(12) Patent Application Publication
(10) Pub. No.: US 2024/0311089 A1
(43) Pub. Date: Sep. 19, 2024

(54) SYSTEMS AND METHODS FOR DETERMINING AN OFFERING IN A COMMUNICATION

(71) Applicant: Engineer.ai Corp., Salt Lake City, UT (US)

(72) Inventors: Sachin Dev Duggal, Salt Lake City, UT (US); Srini Janarthanam, London (GB); Rohan Patel, London (GB); Priyanka Kocchar, London (GB)

(73) Assignee: Engineer.ai Corp., Salt Lake City, UT (US)

(21) Appl. No.: 18/429,395

(22) Filed: Jan. 31, 2024

Related U.S. Application Data
(63) Continuation-in-part of application No. 18/298,036, filed on Apr. 10, 2023.
(63) Continuation-in-part of application No. 18/298,053, filed on Apr. 10, 2023.
(63) Continuation-in-part of application No. 18/298,062, filed on Apr. 10, 2023.
(63) Continuation-in-part of application No. 18/300,381, filed on Apr. 13, 2023.
(63) Continuation-in-part of application No. 18/300,384, filed on Apr. 13, 2023.
(63) Continuation-in-part of application No. 18/300,385, filed on Apr. 13, 2023.

(30) Foreign Application Priority Data
Mar. 14, 2023 (IN) 202341016792

(51) Int. Cl. G06F 8/30; G06Q 10/10

(52) U.S. Cl. CPC G06F 8/30; G06Q 10/103

(57) ABSTRACT

The present disclosure relates to a computer system and method for generating a software application. A method to generate a software application includes receiving, from a user, a request to generate a software application and determining a product or service to which the software application is directed. The method further includes determining a template for the software application based on the product or service and generating a machine readable specification for the software application, the machine readable specification having one or more features based on the template.

### CROSS REFERENCE TO PRIOR APPLICATIONS

This application is a continuation-in-part of the following applications: U.S. patent application Ser. No. 18/298,036, entitled as “METHOD AND SYSTEM FOR APPLICATION PROTOTYPE GENERATION”, filed Apr. 10, 2023, which claims priority to Indian Provisional Patent Application No. 20/234,1016792, entitled as “METHOD AND SYSTEM FOR APPLICATION PROTOTYPE GENERATION”, filed Mar. 14, 2023; U.S. patent application Ser. No. 18/298,053, entitled as “METHOD AND SYSTEM FOR RECOMMENDING LAUNCH SCREENS FOR AN APPLICATION”, filed Apr. 10, 2023, which claims priority to Indian Provisional Patent Application No. 20/234,1016792, entitled as “METHOD AND SYSTEM FOR APPLICATION PROTOTYPE GENERATION”, filed Mar. 14, 2023; U.S. patent application Ser. No. 18/298,062, entitled as “METHOD AND SYSTEM TO GENERATE AND INSTANT APPLICATION”, filed Apr. 10, 2023, which claims priority to Indian Provisional Patent Application No. 20/234,1016792, entitled as “METHOD AND SYSTEM FOR APPLICATION PROTOTYPE GENERATION”, filed Mar. 14, 2023; U.S. patent application Ser. No. 18/300,381, entitled as “SYSTEMS AND METHODS FOR ENHANCING IN-CALL EXPERIENCE OF CUSTOMERS”, filed Apr. 13, 2023; U.S. patent application Ser. No. 18/300,384, entitled as “SYSTEMS AND METHODS FOR ENHANCING CUSTOMER EXPERIENCE”, filed Apr. 13, 2023; and U.S. patent application Ser. No. 18/300,385, entitled “SYSTEMS AND METHOD FOR STANDARDIZING COMMUNICATION”, filed Apr. 13, 2023. Each of the foregoing applications is incorporated by reference in its entirety.

### FIELD OF THE INVENTION

The present disclosure generally relates to determining an offering in a communication regarding development of a software application.

### BACKGROUND

Software applications take considerable expertise and resources to develop. For commercial use, a software application should be designed to work with multiple hardware configurations. Further, many software applications must be configured to connect to an online server to perform various processes. For example, a shopping application may be configured to allow a user to login to a user account on a server, select various products or services, and purchase the selected products or services. Each step that the shopping application performs may require one or more separate sets of functions or modules to perform the step.

As such, even experienced developers may take a significant amount of time to develop any software application. There is a need in the art to simplify software application development to decrease the amount of time that software applications take to develop and to decrease the cost of development as well.

### SUMMARY

The disclosed subject matter includes systems, methods, and computer-readable storage mediums for enhancing in-call customer experience. A method includes receiving a notification about an intended call between a user and a customer and, while the call is in progress, identifying a conversation between the user and the customer to determine customer inputs. The method also includes determining the customer's intent based on the determined customer input and displaying one or more recommendations on a user device communication console while conversing with the customer.

Another general aspect is a computer system to enhance the in-call customer experience. The computer system includes a memory and a processor coupled to the memory. The processor is configured to receive a notification about an intended call between a user and a customer. The processor is also configured to identify a conversation between the user and the customer to determine customer inputs while the call is in progress. The processor is further configured to determine an intent of the customer based on the determined customer input and display one or more recommendations on a user device communication console while the user is conversing with the customer.

An exemplary embodiment is a computer readable storage medium having data stored therein representing software executable by a computer. The software includes instructions that, when executed, cause the computer readable storage medium to perform receiving a notification about an intended call between a user and a customer and identifying a conversation between the user and the customer to determine customer inputs while the call is in progress. The instructions may further cause the computer readable storage medium to perform determining an intent of the customer based on the determined customer input and displaying one or more recommendations on a user device communication console while the user is conversing with the customer.

Another general aspect is a method for standardizing communication. The method includes receiving a notification about an intended communication between a user and customer and identifying a conversation between the user and the customer while the communication is in progress. The method also includes determining one or more topics under discussion from the identified conversation and displaying one or more other topics as recommendations to the user for standardizing the communication.

An exemplary embodiment is a computer system to standardize communication. The computer system includes a memory and a processor coupled to the memory. The processor is configured to receive a notification about an intended communication between a user and customer and identify a conversation between the user and the customer while the communication is in progress. The processor is also configured to determine one or more topics under discussion from the identified conversation and display one or more other topics as recommendations to the user for standardizing the communication.

Another general aspect is a computer readable storage medium having data stored therein representing software executable by a computer. The software includes instructions that, when executed, cause the computer readable storage medium to perform receiving a notification about an intended communication between a user and customer and identifying a conversation between the user and the customer while the communication is in progress. The instructions may further cause the computer readable storage medium to perform determining one or more topics under discussion from the identified conversation and displaying one or more other topics as recommendations to the user for standardizing the communication.

Another exemplary embodiment is a method for enhancing customer experience. The method includes receiving one or more customer inputs while a customer is conversing with a user and predicting a software application of interest for the customer based on the one or more customer inputs. The method also includes generating a buildcard based on the predicted software application.

Another general aspect is a computer system to enhance customer experience. The computer system includes a memory and a processor coupled to the memory. The processor is configured to receive one or more customer inputs while a customer is conversing with a user and predict a software application of interest for the customer based on the user inputs. The processor is also configured to generate a buildcard based on the predicted software application.

An exemplary embodiment is a computer readable storage medium having data stored therein representing software executable by a computer. The software includes instructions that, when executed, cause the computer readable storage medium to perform receiving one or more customer inputs while a customer is conversing with a user and predicting a software application of interest for the customer based on the one or more customer inputs. The instructions may further cause the computer readable storage medium to perform generating a buildcard based on the predicted software application. The disclosed subject matter includes systems, methods, and computer-readable storage mediums for generating a prototype of an application. The method includes receiving an entity specification. The entity specification includes one or more features and application information. The method further includes estimating a linkage for each pair of features of the one or more features and generating the prototype of the application based on the estimated linkage between each pair of features and using the application information.

Another general aspect is a computer system to generate a prototype of an application. The computer system includes a memory and a processor coupled to the memory. The processor is configured to receive an entity specification. The entity specification includes one or more features and application information. The processor is further configured to estimate a linkage for each pair of features of the one or more features and generate the prototype of the application based on the estimated linkage between each pair of features and using the application information.

An exemplary embodiment is a computer readable storage medium having data stored therein representing software executable by a computer. The software includes instructions that, when executed, cause the computer readable storage medium to perform receiving an entity specification. The entity specification includes one or more features and application information. The instructions may further cause the computer readable storage medium to perform estimating a linkage for each pair of features of the one or more features and generating the prototype of the application based on the estimated linkage between each pair of features and using the application information.

Another general aspect is a method for recommending one or more launch screens for an application. The method includes receiving a buildcard. The buildcard includes an application template and one or more features. The method also includes determining a hierarchical relationship between the one or more features and recommending the one or more launch screens for the application based on the determined hierarchical relationship and the application template.

An exemplary embodiment is a computer system to recommend one or more launch screens for an application. The computer system includes a memory and a processor coupled to the memory. The processor is configured to receive a buildcard. The buildcard includes an application template and one or more features. The processor is also configured to determine a hierarchical relationship between the one or more features and recommend the one or more launch screens for the application based on the determined hierarchical relationship and the application template.

Another general aspect is a computer readable storage medium having data stored therein representing software executable by a computer. The software includes instructions that, when executed, cause the computer readable storage medium to perform receiving a buildcard. The buildcard includes an application template and one or more features. The instructions may further cause the computer readable storage medium to perform determining a hierarchical relationship between the one or more features and recommending the one or more launch screens for the application based on the determined hierarchical relationship and the application template.

Another exemplary embodiment is a method for generating an instant application. The method includes receiving a selection of one or more features and an application template and determining a linkage between each pair of features of the one or more selected features. The method also includes processing the one or more selected features based on the determined linkage and generating the prototype of the application based on the processing and using the application template.

Another general aspect is a computer system to generate an instant application. The computer system includes a memory and a processor coupled to the memory. The processor is configured to receive a selection of one or more features and an application template and determine a linkage between each pair of features of the one or more selected features. The processor is also configured to process the one or more selected features based on the determined linkage and generate the prototype of the application based on the processing and using the application template.

An exemplary embodiment is a computer readable storage medium having data stored therein representing software executable by a computer. The software includes instructions that, when executed, cause the computer readable storage medium to perform receiving a selection of one or more features and an application template and determining a linkage between each pair of features of the one or more selected features. The instructions may further cause the computer readable storage medium to perform processing the one or more selected features based on the determined linkage and generating the prototype of the application based the processing and using the application template.

An exemplary embodiment is a method for determining a design for a software application. The method includes receiving, from a user, a description of one or more features of the software application design via a chat module. The method further includes selecting, by a generative AI system, a previous design that most closely corresponds to the one or more features. The method further includes displaying a prototype of the selected design to the user. The method further includes modifying, by the generative AI system, the prototype based on one or more responses from the user received via the chat module. The prototype may be repeatedly modified using an iterative process. The prototype may be displayed as a screen flow view, with arrows representing linkages between the one or more features. The prototype may be displayed as a graph view, with nodes representing the one or more features, and arrows representing linkages between the one or more features. The linkages may be determined based on at least one of historical data and user input. The prototype may be modified and displayed in real time.

Another general aspect is a computer system for determining a design for a software application. The computer system includes a processor coupled to a memory, where the processor is configured to execute software to perform the foregoing method for determining a design for a software application.

An exemplary embodiment is a computer readable storage medium having data stored therein representing software executable by a computer. The software includes instructions that, when executed, cause the computer readable storage medium to perform the foregoing method for determining a design for a software application.

An exemplary embodiment is a method for generating a software application. The method includes converting, by a generative AI system, a description from one or more functions of a software application into features for the software application where the converting includes iterating over a chat process. The chat process includes receiving, from a user, a description for one or more functions for the software application and determining one or more features for the software application that are consistent with the description for the one or more functions. The chat process includes determining whether the description for the software application is complete and iterating over the process again if the description for the software application is not complete. The chat process includes generating a machine readable specification that, when followed, is capable of developing the software application. The chat process may further include determining a question that, when answered, will allow the generative AI system to determine additional features for the software application. The chat process may further include transmitting the question to the client. The method may further include determining a pre-existing template for a machine readable specification based on the determined one or more features. The method may further include modifying the pre-existing template for the machine readable specification based on descriptions for the one or more functions better received during the chat process. The chat process may further include generating a prototype of at least one of the one or more features. The chat process may further include displaying the prototype to the client.

Another general aspect is a computer system to generate a software application. The computer system includes a processor coupled to a memory where the processor is configured to execute a software to perform the foregoing method for generating a software application.

An exemplary embodiment is a computer readable storage medium having data stored therein representing software executable by a computer. The software includes instructions that, when executed, cause the computer readable storage medium to perform the foregoing method for generating a software application.

An exemplary embodiment is a method for determining a proposal for a software application project. The method includes receiving, from a user, a description of one or more features of a software application via a chat module. The method further includes converting, by a generative AI system, the one or more features into one or more jobs based on data from previous software application projects. The method further includes determining, by the generative AI system, the proposal for the software application project based on the one or more jobs. The method further includes displaying the proposal for user approval before beginning the software application project. The proposal may include a cost of the software application project. The proposal may include a timeline of the software application project. The proposal may include both a cost and a timeline of the software application project. The method may include modifying the proposal when a description of a new or additional feature of the software application is received from the user. The proposal may be displayed to the user together with a template or prototype of the software application. The one or more features may correspond to a functionality or appearance of the software application.

Another general aspect is a computer system for determining a proposal for a software application project. The computer system includes a processor coupled to a memory, where the processor is configured to execute software to perform the foregoing method for determining a proposal for a software application project.

An exemplary embodiment is a computer readable storage medium having data stored therein representing software executable by a computer. The software includes instructions that, when executed, cause a computer readable storage medium to perform the foregoing method for determining a proposal for a software application project.

An exemplary embodiment is a method for generating a software application. The method includes receiving, from a user, a request to generate a software application and generating one or more prompts that are configured to produce a response, from the user, that refines a description of the software application. The method further includes determining one or more features of the software application based on one or more responses to the one or more prompts. The method further includes determining a feature template based on the software application. Determining a feature template may include matching a pre-existing feature template to a description of the software application. Determining the feature template may be performed at least once after the description is refined based on the one or more prompts. Each of the one or more prompts may be generated based on training data for previous software application projects. Each prompt may be generated based on a most likely response from the previous software application projects. The method may further include generating a prototype of a feature of the software application based on a response to a prompt and demonstrating the prototype to the user. The demonstrating may include displaying an image based on the response to the prompt.

Another general aspect is a computer system to generate a software application. The computer system includes a processor coupled to a memory, the processor configured to execute software to perform the foregoing method for generating a software application.

An exemplary embodiment is a computer readable storage medium having data stored therein representing software executable by computer. The software includes instructions that, when executed, cause the computer readable storage medium to perform the foregoing method for generating a software application.

An exemplary embodiment is a method for generating a software application. The method includes engaging in a conversation with a user via a chat module about an idea for the software application. The method further includes identifying, by a generative AI system, one or more features of the software application based on the conversation with the user. The method further includes converting, by the generative AI system, the one or more features into a machine-readable specification for generating the software application. The one or more features may be identified by referring to previous software applications. The method may further include displaying a template of the software application to the user. The one or more features may be identified by extracting key words using natural language processing. The keywords may be translated into actionable items. The chat module may prompt the user to describe the appearance and behavior of the software application. The method may include scanning the conversation for inappropriate content.

Another general aspect is a computer system for generating a software application. The computer system includes a processor coupled to a memory, where the processor is configured to execute software to perform the foregoing method for generating a software application.

An exemplary embodiment is a computer readable storage media having data stored therein representing software executable by a computer. The software includes instructions that, when executed, cause the computer readable storage medium to perform the foregoing method for generating a software application.

An exemplary embodiment is a method for generating a software application. The method includes receiving, from a user, a request to generate a software application and determining a product or service to which the software application is directed. The method further includes determining a template for the software application based on the product or service and generating a machine readable specification for the software application, the machine readable specification having one or more features based on the template. The method may further include determining one or more features for the software application based on the determined product or service. The method may further include generating one or more prompts that are configured to produce a response, from the client user, that refines the determined product or service. The method may further include determining one or more features for the software application based on the refined determined product or service. The method may further include determining a price to develop the software application and transmitting the price to the user. The method may further include determining a timeline to develop the software application and transmitting the timeline to the user. The method may further include generating a prototype of a feature of the software application based on a response to a prompt and demonstrating the prototype to the user.

Another general aspect is a computer system to generate a software application. The computer system includes a processor coupled to a memory where the processor is configured to execute software to perform the foregoing method for generating a software application.

An exemplary embodiment is a computer readable storage medium having data stored therein representing software executable by computer. The software includes instructions that, when executed, cause the computer readable storage medium to perform the foregoing method for generating a software application.

An exemplary embodiment is a method for determining a template for a software application. The method includes receiving, from a user, a description of one or more features of the software application via a chat module. The method further includes determining, by a generative AI system, a template for the software application based on the one or more features. The method further includes modifying, by the generative AI system, the template based on one or more responses from the user received via the chat module. The template may be a preexisting template from a prior software application. The template may be a custom template created based on input from the user. The template may be a template website. The template may be modified to include different colors, imagery, or textual components. The template may be repeatedly modified using an iterative process and displayed to the user in real time. The method may further include generating a machine-readable specification for the software application based on the template.

Another general aspect is a computer system for determining a template for a software application. The computer system includes a processor coupled to a memory, where the processor is configured to execute software to perform the foregoing method for determining a template for a software application.

An exemplary embodiment is a computer readable storage media having data stored therein representing software executable by a computer. The software includes instructions that, when executed, cause the computer readable storage medium to perform the foregoing method for determining a template for a software application.

An exemplary embodiment is a method for determining a cost for developing features of a software application. The method includes receiving, from a user, a description of one or more features of the software application via a chat module. The method further includes determining, by a generative AI system, whether the one or more features are custom features. The method further includes determining, in a case the one or more features are determined to be custom features, a cost to develop the one or more features. The cost may be determined based on similarity of the one or more features to previously developed features. The determination of whether the one or more features are custom features may be based on historical data and input from the user. The method may further include generating a prototype of the one or more features, and displaying the prototype to the user. The method may further include determining a timeline to develop the one or more features. The method may further include displaying the determined cost to the user before beginning development of the software application. The method may further include generating a machine-readable specification for the software application, where the machine-readable specification includes a marker that identifies a customizable portion corresponding to the one or more features.

Another general aspect is a computer system for determining a cost for developing features of a software application. The computer system includes a processor coupled to a memory, where the processor is configured to execute software to perform the foregoing method for determining a cost for developing features of a software application.

An exemplary embodiment is a computer readable storage medium having data stored therein representing software executable by a computer. The software includes instructions that, when executed, cause the computer readable storage medium to perform the foregoing method for determining a cost for development features of a software application.

An exemplary embodiment is a method for refining a feature of a software application. The method includes receiving, from a user, a description of one or more functions of the software application via a chat module. The method further includes converting, by a generative AI system, the one or more functions into one or more features of the software application. The method further includes refining by the generative AI system, the one or more features based on responses from the user received via the chat module. The method may further include generating a template containing the one or more features and displaying the template to the user. The template may be modified based on the responses to include the refined one or more features. The method may further include generating a prototype of the one or more features, and modifying the prototype based on the responses to demonstrate the refined one or more features. The refining may be repeated using an iterative process. The method may further include generating a prompt to the user to provide a minimum number of details for each of the one or more functions. The minimum number of details may be dependent on a type of function.

Another general aspect is a computer system for refining a feature of a software application. The computer system includes a processor coupled to a memory, where the processor is configured to execute software to perform the foregoing method for refining a feature of a software application.

An exemplary embodiment is a computer readable storage medium having data stored therein representing software executable by a computer. The software includes instructions that, when executed, cause the computer readable storage medium to perform the foregoing method for refining a feature of a software application.

The systems, methods, and computer readable storage media of the present disclosure overcome one or more of the shortcomings of the prior art. Additional features and advantages may be realized through the techniques of the present disclosure. Other embodiments and aspects of the disclosure are described in detail herein and are considered a part of the claimed disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating the computing components that may be used to implement various features of embodiments described in the disclosed subject matter.

FIG. 6 is a schematic illustrating a system in an embodiment of the disclosed subject matter.

FIG. 7 is a flow diagram illustrating a method for enhancing the in-call experience of customers in an embodiment of the disclosed subject matter.

FIG. 8 is a flow diagram illustrating a method for standardizing communication in an embodiment of the disclosed subject matter.

FIG. 9 is a flow diagram illustrating a method for enhancing customer experience in an embodiment of the disclosed subject matter.

FIG. 10 is a schematic diagram of an automated web application development system in an embodiment of the disclosed subject matter.

FIG. 11 is a schematic for a system to interact and generate content responsive to automated communication in an embodiment of the disclosed subject matter.

FIG. 12 is a flow diagram for a system in an embodiment of the disclosed subject matter.

FIG. 13 is a schematic for an embodiment of a prototype generation system of the disclosed subject matter.

FIG. 14 is a flow diagram 1400 for an embodiment of a process of generating a prototype of an application.

FIG. 15 is a flow diagram for a process 1500 for generating a response to chat interaction by an automated system.

FIG. 16A is a flow diagram for another embodiment of the process of generating a prototype of an application.

FIG. 16B is a flow diagram for an embodiment of the process of recommending one or more launch screens for an application.

FIG. 16C is a flow diagram for an embodiment of the process of generating an instant application.

FIG. 17A is an illustration of a screen flow view of an exemplary application.

FIG. 17B is an illustration of a subset of screen flow view of an exemplary application.

FIG. 18A is an illustration of a screen flow view of an exemplary application for web platform.

FIG. 18B is an illustration of a subset of screen flow view from FIG. 18A.

FIG. 19A is an illustration of a subset of screen flow view of an exemplary application for web platform.

FIG. 19B is an illustration of a prototype represented as a graph for an exemplary application.

FIGS. 20A-20B are illustrations of launch screens for two different exemplary applications.

FIG. 21 is a screenshot showing data variables and a hero image that is modified by data variables.

FIGS. 22-29 are a series of screenshots depicting a generative AI system that generates web page content in real time based on an interaction of a chat system with a user.

FIG. 30 is a flow diagram for a process of determining a web page design for an idea.

FIG. 31 is a flow diagram for a process for converting an idea into a machine-readable specification.

FIG. 32 is a flow diagram for a process for determining a proposal for a project.

FIG. 33 is a flow diagram for a process for determining questions to ask a user to discern desired features for a project.

FIG. 34 is a flow diagram for a process for generating a software application based on a conversation with a user.

FIG. 35 is a flow diagram for a process for determining products or services based on a conversation.

FIG. 36 is a flow diagram for a process for determining a template for a software application.

FIG. 37 is a flow diagram for a process for determining a cost for developing features of a software application.

FIG. 38 is a flow diagram for a process for refining a feature of a software application.

FIG. 39 is a flow diagram for a process for generating an image for a software application.

### DETAILED DESCRIPTION

The disclosed subject matter comprises systems, methods, and computer readable storage mediums for enhancing in-call customer experience. A method includes receiving a notification about an intended call between a user and a customer and identifying a conversation between the user and the customer to determine customer inputs while the call is in progress. The method also includes determining the customer's intent based on the determined customer input and displaying one or more recommendations on a user device communication console while conversing with the customer.

In various embodiments, the disclosed subject matter is a system and method of determining a web page design for an idea. The generative AI may generate a design specification based on one or more features. For example, the generative AI may select a previous design that most closely fits one or more features that are specified by a user. A prototype of the selected design may be displayed to the user and further modified based on one or more responses from the user.

In an exemplary embodiment, the disclosed subject matter is a system and method for converting a description for a software application into a machine-readable specification. The machine-readable specification may be followed by one or more developers, designers, and or automated systems to create a software application. In various embodiments, a natural language processing (NLP) system may be used to converse with a user or client that is describing the software application they wish to create. In an exemplary embodiment, the NLP system may determine one or more features for the software application based on a conversation with the user.

The user interacts with the generative AI system via natural language to describe a software application. The generative AI determines features for the software application and creates a machine-readable specification that includes instructions to develop the features.

In an exemplary embodiment, the disclosed subject matter is a system and method for determining a cost and timeline for a project. The generative AI uses data from previous projects to generate a proposal for required work and cost of a project to develop a software application. For example, the generative AI may convert one or more features into one or more jobs that have a cost to complete a project. The total cost to complete the project may be presented by the generative AI to a user for approval before beginning the project.

In an exemplary embodiment, the disclosed subject matter is a system and method for determining questions to ask a user to determine the users desired features for a project to develop a software application. A generative AI may use natural language processing to converse with the user to determine features that the user desires for a software application. The generative AI may use data from previous projects to generate questions to be answered for the most relevant feature decisions for software application. For example, in a software application that is designed to keep an inventory for products that are stored in a warehouse, a major design decision may be whether client devices have read/write access to inventory. The generative AI may ask the user whether clients will have read/write access and the software application so that it may create a buildcard with that feature.

In an exemplary embodiment, the disclosed subject matter is a system and method for determining features for an idea based on a conversation. The generative AI may use natural language processing to generate features for a software application based on a conversation with a user. For example, an AI bot may generate a set of one or more specific features for software application that can be converted into a machine-readable specification. In one instance, the set of one or more features may be (1) a website to shop for products, (2) a customer may browse through images of the products, (3) the customer may select products to purchase, and (4) the customer may purchase the selected products.

In an exemplary embodiment, the disclosed subject matter is a system and method for determining products or services based on a conversation. A generative AI may use natural language processing to ask directed questions to determine what kind of product or service a user wishes a software application to perform. The generative AI may generate various designs and features for the software application based on product or service. For example, the automated system may ask a user what he/she wants the software application to perform. The user may respond by saying they want a service for employees to communicate with one another. Based on this response the system may ask a question to narrow down product or service by asking whether employee communication would be routed through a manager. Accordingly, the generative AI could generate various designs and features that are directed to the specific service requested by the user.

In an exemplary embodiment, the disclosed subject matter is a system and method for determining a template for a software application based on a conversation. A generative AI system may use natural language processing to converse with a user and determine one or more features of a software application. The generative AI may determine a template for the software application based on these features and display the template to the user. For instance, the template can be a sample webpage. The system may make changes to the displayed template based on further input from the user.

In an exemplary embodiment, the disclosed subject matter is a system and a method for determining a cost for developing features based on a conversation. A generative AI system may use natural language processing to converse with a user and determine one or more features of a software application. The automated system may then determine if the features are custom or novel features (e.g., features that have not been previously developed). If so, then the generative AI may determine a cost to develop the features and the cost is displayed to the user.

In an exemplary embodiment, the disclosed subject matter is a system and a method for refining a feature for a software application based on a conversation. A generative AI system may use natural language processing to converse with a user and determine a feature of a software application. Then, the system may make incremental changes to the feature based on direction from the user.

In an exemplary embodiment, the disclosed subject matter is a system and method for generating images for a software application based on a conversation. A generative AI system may use natural language processing to converse with a user and determine one or more features of a software application. The system may generate an image based on the these features. Then, similar to refining a feature, incremental changes may be made to the image based on the conversation.

The term “user” as used herein refers to an individual such as a consumer, agent for an organization, or the like that is interacting with the disclosed generative AI system in order to create a software application.

Embodiments, of the present disclosure, will now be described with reference to the accompanying drawing. Embodiments are provided to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments may not be construed to limit the scope of the present disclosure. In some embodiments, well-known processes, apparatus structures, and techniques are not described in detail.

The terminology used, in the present disclosure, is to explain a particular embodiment and such terminology may not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as requiring their performance as described or illustrated. It is also to be understood that additional or alternative steps may be employed.

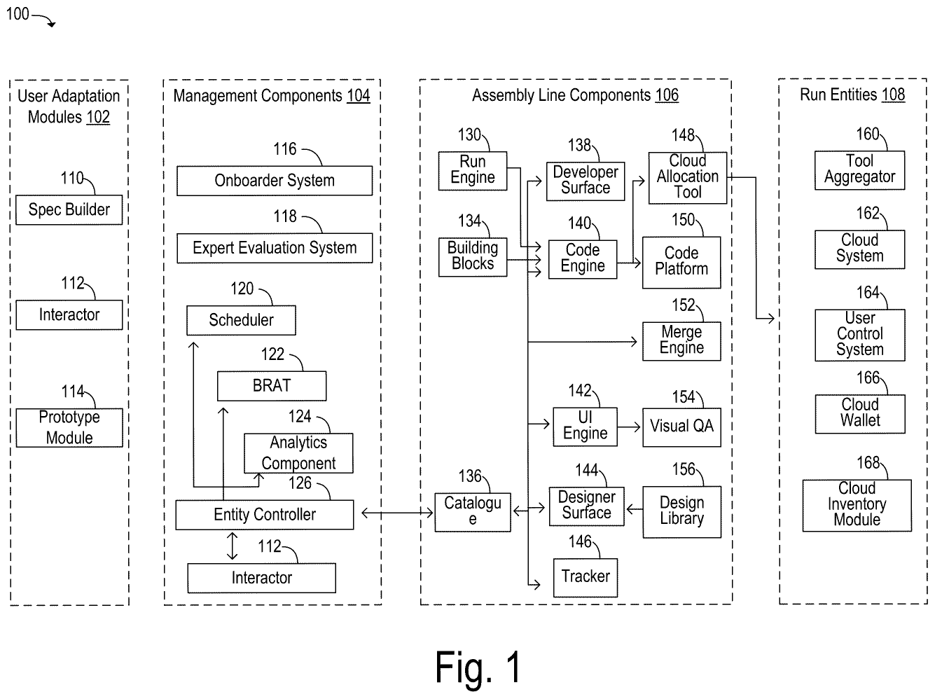

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. User adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. Specification builder 110, the interactor 112 system, and the prototype module 114 may be used concurrently and/or link to one another. For instance, specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

The specification builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, every building block component 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for casy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

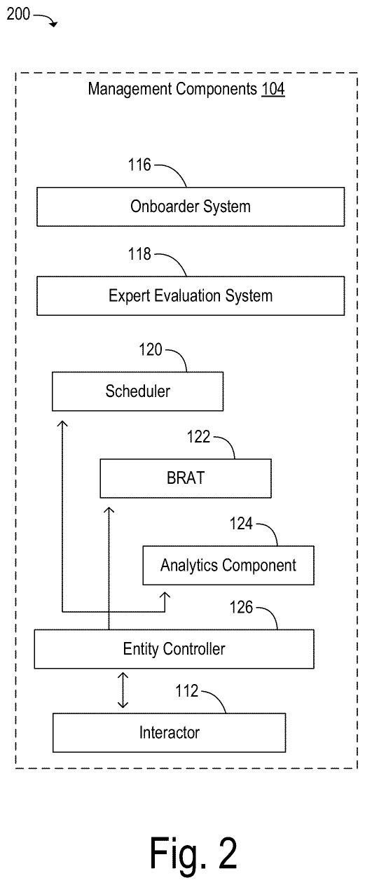

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

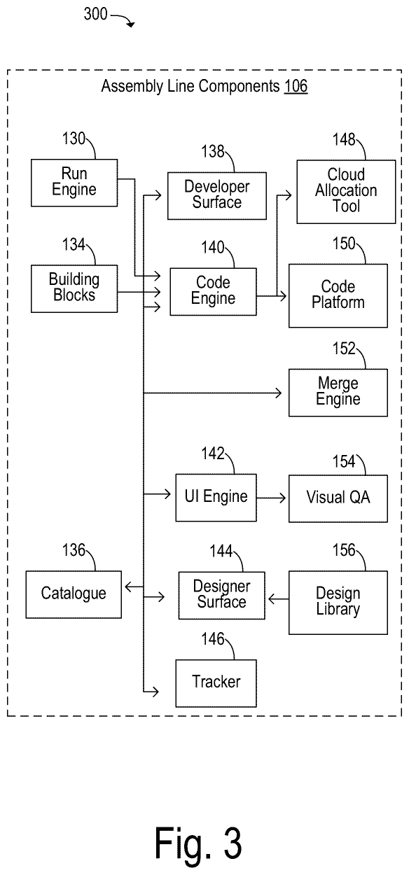

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

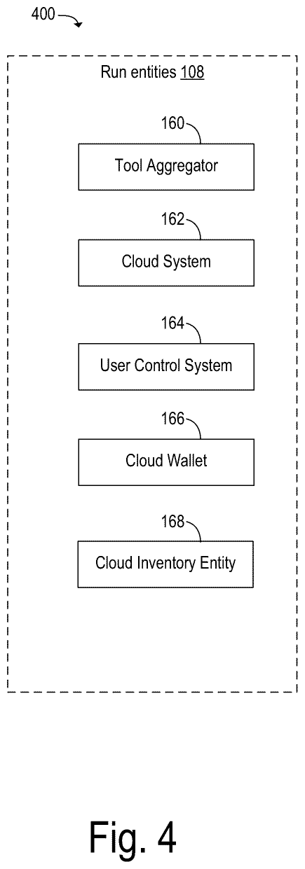

Referring to FIG. 4, FIG. 4 is a schematic 400 illustrating an embodiment of the run entities 108 of the software building system. The run entities 108 provides a user with 3rd party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3rd party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

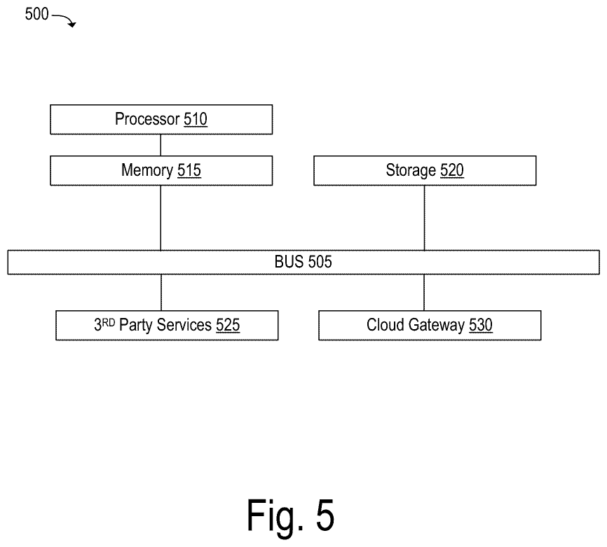

Referring to FIG. 5, FIG. 5 is a schematic illustrating a computing system 500 that may be used to implement various features of embodiments described in the disclosed subject matter. The terms components, entities, modules, surface, and platform, when used herein, may refer to one of the many embodiments of a computing system 500. The computing system 500 may be a single computer, a co-located computing system, a cloud-based computing system, or the like. The computing system 500 may be used to carry out the functions of one or more of the features, entities, and/or components of a software project.

The exemplary embodiment of the computing system 500 shown in FIG. 5 includes a bus 505 that connects the various components of the computing system 500, one or more processors 510 connected to a memory 515, and at least one storage 520. The processor 510 is an electronic circuit that executes instructions that are passed to it from the memory 515. Executed instructions are passed back from the processor 510 to the memory 515. The interaction between the processor 510 and memory 515 allow the computing system 500 to perform computations, calculations, and various computing to run software applications.

Examples of the processor 510 include central processing units (CPUs), graphics processing units (GPUs), field programmable gate arrays (FPGAs), complex programmable logic devices (CPLDs), and application specific integrated circuits (ASICs). The memory 515 stores instructions that are to be passed to the processor 510 and receives executed instructions from the processor 510. The memory 515 also passes and receives instructions from all other components of the computing system 500 through the bus 505. For example, a computer monitor may receive images from the memory 515 for display. Examples of memory include random access memory (RAM) and read only memory (ROM). RAM has high speed memory retrieval and does not hold data after power is turned off. ROM is typically slower than RAM and does not lose data when power is turned off.

The storage 520 is intended for long term data storage. Data in the software project such as computer readable specifications, code, designs, and the like may be saved in a storage 520. The storage 520 may be stored at any location including in the cloud. Various types of storage include spinning magnetic drives and solid-state storage drives.

The computing system 500 may connect to other computing systems in the performance of a software project. For instance, the computing system 500 may send and receive data from 3rd party services such as Office 365 and Adobe. Similarly, users may access the computing system 500 via a cloud gateway 530. For instance, a user on a separate computing system may connect to the computing system 500 to access data, interact with the run entities 108, and even use 3rd party services 525 via the cloud gateway.

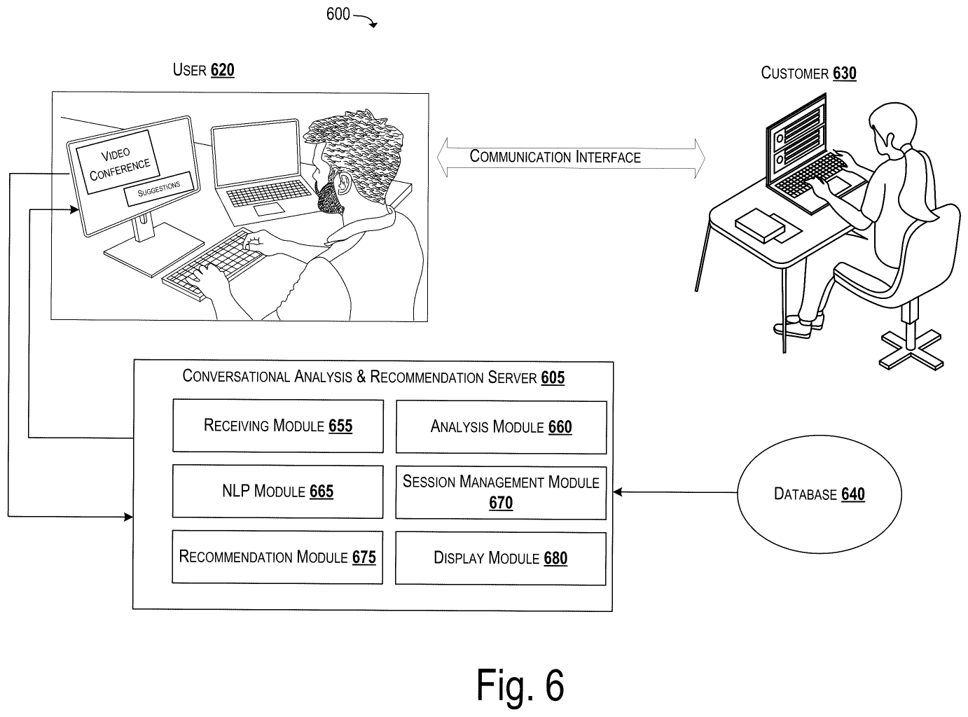

Referring to FIG. 6, FIG. 6 is a schematic diagram of a conversational analysis and recommendation system 600 in an embodiment of the disclosed subject matter. In an exemplary embodiment, the conversational analysis and recommendation system 600 comprises a conversational analysis and recommendation server 605, a user 620, a customer 630, and a database 640. The conversational analysis and recommendation server 605 may be a computing system 500 configured to operate the user adaptation modules 102, the management components 104, the assembly line components 106, and the run entities 108.

The conversational analysis and recommendation server 605 is configured to assist the user to improve the customer experience when the customer 630 is interacting with the user 620. In one embodiment, the user 620 can be a developer, a designer, a productologist, or any person of the organization. During each user 620 conversation with the customer 630, the conversational analysis and recommendation server 605 works as an assistant and provides the user 620 with one or more right questions to ask the customer 630. The conversational analysis and recommendation server 605 also listens to customer answers and performs one or more activities such as adding relevant features to generate a buildcard, providing future questions, and so on. With the help of the conversational analysis and recommendation server 605, every conversation with the customer 630 is standardized and the customer 630 communication with each user is precise and competent, as each user is provided real-time support with the assistance of the conversational analysis and recommendation server 605.

In one example, the conversational analysis and recommendation server 605 may be configured as a standalone system. The conversational analysis and recommendation server 605 also includes an interface provided therein for interacting with the data repository (or database) 640, such as the knowledge graph database. The conversational analysis and recommendation server 605 comprises one or more components coupled with each other that may be deployed on a single system or different systems. In an embodiment, the conversational analysis and recommendation server 605 comprises a receiving module 655, an analysis module 660, a natural language processing (NLP) module 665, a session management module 670, a recommendation module 675, a display module 680, and other modules (not shown).

As used herein, the term module refers to an application-specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules may be used to perform various miscellaneous functionalities of the conversational analysis and recommendation server 605. It will be appreciated that such modules may be represented as a single module or a combination of different modules.

In an embodiment, the receiving module 655 is configured to receive a notification about any scheduled communication such as a call, meeting, etc. The receiving module 655 may receive the notification about such intended communication using a calendar event of the user 620, a message in a device associated with the user 620, or any email communication. In any exemplary embodiment, the receiving module 655 may implement a crawler to receive the notifications.

In an embodiment, the analysis module 660 is coupled to the receiving module 655. The analysis module 660 comprises one or more speech recognition and text recognition modules installed in the device associated with the user 620. The analysis module 660 is configured to identify an ongoing conversation between the user 620 and the customer 630 by using one or more software programs or functions installed in the device associated with the user 620. The analysis module 660 is also configured to determine customer queries in the form of customer inputs from the identified conversation. In an exemplary embodiment, the analysis module 660 is configured to determine customer inputs by processing the conversation to an n-gram language model.

In an embodiment, the NLP module 665 is coupled to the analysis module 660. The NLP module 665 is configured to The NLP module 665 comprises one or more models, such as an intent classifier model, a feature tagging model, a feature recommendation model, an entity tagger model, a response classifier model, and a prompt mirroring model.

In an exemplary embodiment, the NLP module 665 is configured to determine an intent of the customer based on the determined customer inputs or queries. In one embodiment, the intent can be a question or an answer to an already raised question by the user 620. In an embodiment, the NLP module 665 is configured to generate one or more responses based on the determined intent and the customer input. Further, in one embodiment, the NLP module 665 is configured to encode the customer input and the one or more responses to obtain an encoded vectorial representation of the customer input and a plurality of encoded vectorial representations of the one or more responses.

In some embodiments, the NLP module 665 includes a ranking module that is configured to rank each of the one or more responses based on the plurality of encoded vectorial representations of the one or more responses. In any exemplary embodiment, in order to rank each of the one or more responses, the NLP module 665 includes a computation module that is configured to compute a dot product between the encoded vectorial representation of the customer input and the plurality of encoded vectorial representations of the one or more responses to obtain a score value for each of the one or more responses. Using the score value for each of the responses, the ranking module configured to rank each of the responses based on the computed score.

In an exemplary embodiment, the NLP module 665 includes a pre-trained language model that is trained before performing the encoding operation on the pre-trained language model via an encoder. The training operation performed on the encoder includes a pre-training and fine-tuning phases. In one embodiment, the pre-training phase includes pre-training the encoder according to a masked and permuted language modeling process. In the same embodiment, the fine-tuning phase includes training the pre-trained encoder according to a next-sentence prediction outcome task.

In some embodiments, the NLP module 665 is configured to identify one or more sections of the conversation based on the determined intent and the one or more customer inputs. In an exemplary embodiment, the NLP module 665 is configured to identify the one or more sections by processing the conversation to an n-gram language model. In one embodiment, the NLP module 665 is configured to run one or more models for the identified one or more sections of the conversation. For example, the feature tagging model is configured to determine or tag one or more features required for a software application based on the identified one or more sections. In another example, the feature recommendation model is configured to recommend one or more features required for the software application development based on the identified one or more sections. Similarly, in another example, the template recommendation model is configured to recommend one or more templates required for the software application development based on the identified one or more sections.

In one embodiment, the NLP module 665 is configured to compare the one or more sections with one or more standard topics. In one embodiment, the one or more standard topics can be a feature selection topic, a template selection topic, a complexity of project discussion topic, a timeline discussion topic, and a cost discussion topic. Upon the comparison, the NLP module 665 is configured to determine one or more topics under discussion based on the comparison. In one embodiment, the NLP module 665 is configured to update one or more status flags corresponding to the determined one or more topics as completed based on the determined one or more topics and store the updated one or more status flags in the database. In one embodiment, one or more status flags are associated with one or more standard topics. In one embodiment, the NLP module 665 is configured to use at least one of a dot product computation or a cosine similarity index for the comparison.

In one embodiment, the session management module 670 is configured to manage one or more sessions between the user 620 and the customer 630. In one embodiment, the session management module 670 is configured to auto-connect the user 620 and the customer 630 when any ongoing session between the user 620 and the customer 630 is disconnected or ended abruptly.

In one embodiment, the recommendation module 675 is coupled to the NLP module 665. The recommendation module 675 is configured to recommend a top-ranked response from the one or more responses. In another embodiment, the recommendation module 675 is configured to predict a software application based on the determined template. Further, the recommendation module 675 is also configured to generate the buildcard based on the predicted software application and the determined one or more features. Further, the recommendation module 675 is also configured to generate the complexity of the software application and a timeline required for developing the software application for the generated buildcard. The recommendation module 675 is configured to generate the complexity of the software application and the timeline needed by retrieving the historical data from the database and using one of the machine learning models from the NLP module 665.

In one embodiment, the display module 680 is coupled to the recommendation module 675. In one embodiment, the display module 680 is configured to display the one or more recommendations on a communication console of user device while the user 620 is conversing with the customer 630. In another embodiment, the display module 680 is configured to display the generated buildcard, the complexity of the software, and the timeline required while the user 620 is conversing with the customer 630. In another embodiment, the display module 680 is configured to display one or more other topics for the discussion as recommendations to have standardized communication with the customer 630, even by an inexperienced user. The standardized communication here may refer to discussing each and every sections that are required for the software application development without missing any section. Further, by displaying the recommendations on the display module 680, the user 620 can instantly give suggestions without having a delay when the conversation is going on with the customer 630.

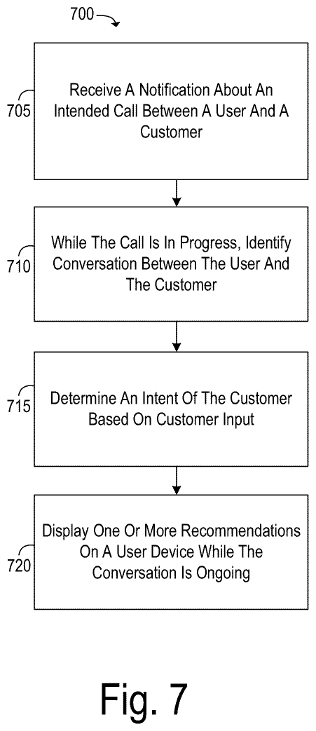

Referring to FIG. 7, FIG. 7 is a flow diagram 700 for an embodiment of a process of enhancing in-call customer experience. The process may be utilized by one or more modules in the conversational analysis and recommendation server 605 for enhancing in-call customer experience. The order in which the process/method 700 is described is not intended to be construed as a limitation, and any number of the described method blocks can be combined in any order to implement the method 700. Additionally, individual blocks may be deleted from the method 700 without departing from the spirit and scope of the subject matter described herein. Furthermore, the method 700 can be implemented in any suitable hardware, software, firmware, or combination thereof.

At step 705, the process may receive a notification about an intended call between the user 620 and the customer 630. In an embodiment, the receiving module 655 is configured to receive a notification about any scheduled communication such as a call, meeting, etc. The receiving module 655 may receive the notification about such intended communication using a calendar event of the user 620, a message in a device associated with the user 620, or any email communication. In any exemplary embodiment, receiving module 655 may implement a crawler to receive the notifications.

At step 710, the process may identify a conversation between the user 620 and the customer 630 while the call is in progress. In an embodiment, the analysis module 660 is coupled to the receiving module 655. The analysis module 660 comprises one or more speech recognition and text recognition modules installed in the device associated with the user 620. The analysis module 660 is configured to identify an ongoing conversation between the user 620 and the customer 630 by using one or more software programs or functions installed in the device associated with the user 620. The analysis module 660 is also configured to determine customer queries in the form of customer inputs from the identified conversation. In any exemplary embodiment, the analysis module 660 is configured to determine customer inputs by processing the conversation to an n-gram language model.

At step 715, the process may determine an intent of the customer based on the customer input. In an exemplary embodiment, the NLP module 665 is configured to determine an intent of the customer based on the determined customer inputs or queries. In one embodiment, the intent can be a question or an answer to an already question raised by the user 620.

At step 720, the process may display one or more recommendations on a user device while the conversation continues. In an embodiment, the NLP module 665 is configured to generate one or more responses based on the determined intent and the customer input. In one embodiment, the one or more responses are generated according to a knowledge graph. For example, the primary entity is determined from the customer input is determined and is located as a node of the knowledge graph. The one or more responses are identified as nodes connected to the node which is represented as the primary entity. The number of connections and type of connections for selecting the nodes connected to the node which is represented as the primary entity is determined based on the determined intent. In other embodiment, the contextual information is also taken into generated and appended to the one or more responses.

Further, in one embodiment, the NLP module 665 is configured to encode the customer input and the one or more responses to obtain an encoded vectorial representation of the customer input and a plurality of encoded vectorial representations of the one or more responses.

In some embodiments, the NLP module 665 includes a ranking module that is configured to rank each of the one or more responses based on the plurality of encoded vectorial representations of the one or more responses. In any exemplary embodiment, in order to rank each of the one or more response, the NLP module 665 includes a computation module that is configured to compute a dot product between the encoded vectorial representation of the customer input and the plurality of encoded vectorial representations of the one or more responses to obtain a score value for each of the one or more responses. Using the score value for each of the responses, the ranking module configured to rank each of the responses based on the computed score.

In an exemplary embodiment, the NLP module 665 includes a pre-trained language model that is trained before performing the encoding operation on the pre-trained language model via an encoder. The training operation performed on the encoder includes a pre-training and fine-tuning phases. In one embodiment, the pre-training phase includes pre-training the encoder according to a masked and permuted language modeling process. In the same embodiment, the fine-tuning phase includes training the pre-trained encoder according to a next-sentence prediction outcome task. Thereafter, the recommendation module 675 is configured to recommend a top-ranked response from the one or more responses and the display module 680 is configured to display the one or more recommendations on a communication console of user device while the user 620 is conversing with the customer 630.

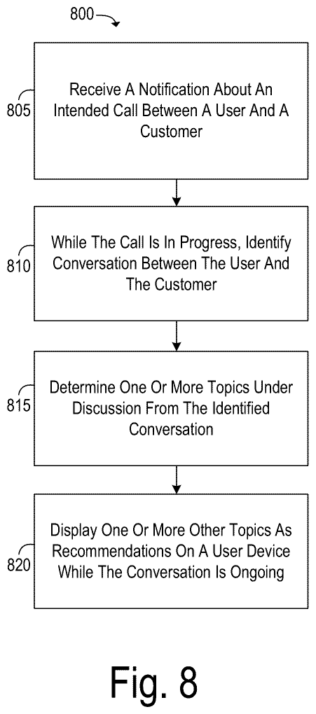

Referring to FIG. 8, FIG. 8 is a flow diagram 800 for an embodiment of a process of standardizing communication. The process may be utilized by one or more modules in the conversational analysis and recommendation server 605 for standardizing communication. The order in which the process/method 800 is described is not intended to be construed as a limitation, and any number of the described method blocks can be combined in any order to implement the method 800. Additionally, individual blocks may be deleted from the method 800 without departing from the spirit and scope of the subject matter described herein. Furthermore, the method 800 can be implemented in any suitable hardware, software, firmware, or combination thereof.

At step 805, the process may receive a notification about an intended call between the user 620 and the customer 630. In an embodiment, the receiving module 655 is configured to receive a notification about any scheduled communication such as a call, meeting, etc. The receiving module 655 may receive the notification about such intended communication using a calendar event of the user 620, a message in a device associated with the user 620, or any email communication. In any exemplary embodiment, receiving module 655 may implement a crawler to receive the notifications.

At step 810, the process may identify a conversation between the user 620 and the customer 630 while the call is in progress. In an embodiment, the analysis module 660 is coupled to the receiving module 655. The analysis module 660 comprises one or more speech recognition and text recognition modules installed in the device associated with the user 620. The analysis module 660 is configured to identify an ongoing conversation between the user 620 and the customer 630 by using one or more software programs or functions installed in the device associated with the user 620. The analysis module 660 is also configured to determine customer queries in the form of customer inputs from the identified conversation. In any exemplary embodiment, the analysis module 660 is configured to determine customer inputs by processing the conversation to an n-gram language model.

At step 815, the process may determine one or more topics under discussion from the identified conversation. In some embodiments, the NLP module 665 is configured to identify one or more sections of the conversation based on the determined intent and the one or more customer inputs. In any exemplary embodiment, the NLP module 665 is configured to identify the one or more sections by processing the conversation to an n-gram language model.

In one embodiment, the NLP module 665 is configured to compare the one or more sections with one or more standard topics. In one embodiment, the one or more standard topics can be a feature selection topic, a template selection topic, a complexity of project discussion topic, a timeline discussion topic, and a cost discussion topic. Upon the comparison, the NLP module 665 is configured to determine one or more topics under discussion based on the comparison. In one embodiment, the NLP module 665 is configured to update one or more status flags corresponding to the determined one or more topics as completed based on the determined one or more topics and store the updated one or more status flags in the database. In one embodiment, one or more status flags are associated with one or more standard topics. In one embodiment, the NLP module 665 is configured to use at least one of a dot product computation or a cosine similarity index for the comparison.

At step 820, the process may display one or more other topics as recommendations on the user device. In an embodiment, the display module 680 is configured to display one or more other topics for the discussion as recommendations to have standardized communication with the customer 630, even by an inexperienced user. Further, by displaying the recommendations on the display module 680, the user 620 can instantly give suggestions without delay when the conversation is going on with the customer 630. Upon displaying the one or more other topics for the discussion, the conversational analysis and recommendation server 605 continues listening to ongoing conversation between the user 620 and the customer 630 and determines that the ongoing conservation is initiated from the recommendations. Further, the conversational analysis and recommendation server 605 updates at least one of the one or more status flags related to the ongoing conversation as completed and recommends at least one of the one or more standard topics based on the updated status flag associated with each of the one or more standard topics. Thereafter, the conversational analysis and recommendation server 605 displays the one or more other topics based on the recommended at least one of the one or more standard topics and iterates the above steps until each of the status flags is updated as completed.

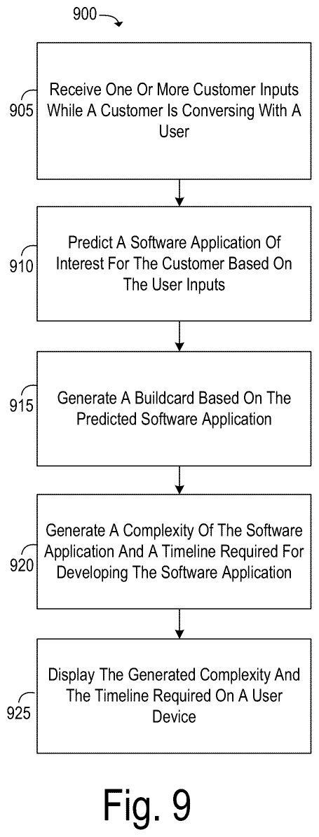

Referring to FIG. 9, FIG. 9 is a flow diagram 900 for an embodiment of a process of enhancing customer experience. The process may be utilized by one or more modules in the conversational analysis and recommendation server 605 for enhancing customer experience. The order in which the process/method 900 is described is not intended to be construed as a limitation, and any number of the described method blocks can be combined in any order to implement the method 900. Additionally, individual blocks may be deleted from the method 900 without departing from the spirit and scope of the subject matter described herein. Furthermore, the method 900 can be implemented in any suitable hardware, software, firmware, or combination thereof.

At step 905, the process may receive one or more customer inputs from the conversation between the user 620 and the customer 630 while the call is in progress. In an embodiment, the receiving module 655 comprises one or more speech recognition and text recognition modules installed in the device associated with the user 620. The receiving module 655 is configured to identify ongoing conversation between the user 620 and the customer 630 by using one or more software programs or functions installed in the device associated with the user 620.

At step 910, the process may predict a software application of interest for the customer based on the one or more customer inputs. In an exemplary embodiment, the NLP module 665 is configured to determine an intent of the customer based on the determined customer inputs or queries. In one embodiment, the intent can be a question or an answer to an already raised question by the user 620. In some embodiments, the NLP module 665 is configured to identify one or more sections of the conversation based on the determined intent and the one or more customer inputs. In an exemplary embodiment, the NLP module 665 is configured to identify the one or more sections by processing the conversation to an n-gram language model. In one embodiment, the NLP module 665 is configured to run one or more models for the identified one or more sections of the conversation. For example, the feature tagging model is configured to determine or tag one or more features required for a software application based on the identified one or more sections. In another example, the feature recommendation model is configured to recommend one or more features required for the software application development based on the identified one or more sections. Similarly, in another example, the template recommendation model is configured to recommend one or more templates required for the software application development based on the identified one or more sections. The recommendation module 675 is configured to predict a software application based on the determined template.

At step 915, the process may generate a buildcard based on the predicted software application. The recommendation module 675 is also configured to generate the buildcard based on the predicted software application and the determined one or more features.

At step 920, the process may generate a complexity of the software application and a timeline required for developing the software application. The recommendation module 675 is also configured to generate the complexity of the software application and a timeline required for developing the software application for the generated buildcard. The recommendation module 675 is configured to generate the complexity of the software application and the timeline required by retrieving the historical data from the database and using one of the machine learning models from the NLP module 665.

At step 925, the process may display the generated complexity of the software application and the timeline required for developing the software application. The display module 680 is also configured to display the generated complexity of the software application and the timeline required for developing the software application for the generated buildcard.

Thus, with the help of the methods explained above, the conversational analysis and recommendation server 605 standardize every conversation with the customer 630. Further, the customer 630 communication with each user is precise and competent, as each user is provided real-time support with the assistance of the conversational analysis and recommendation server 605.

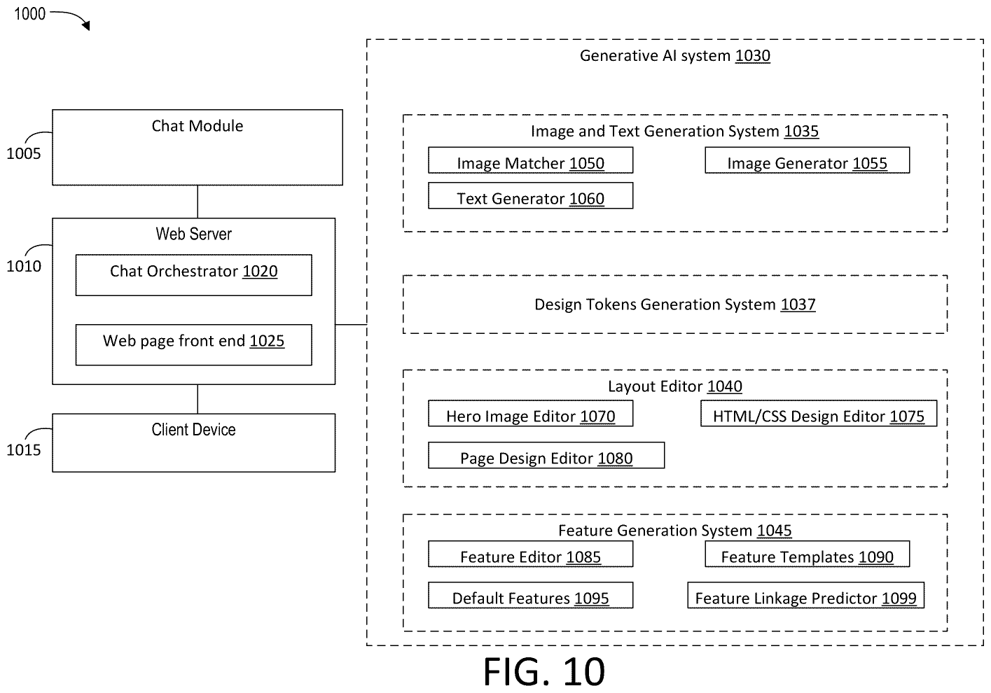

Referring to FIG. 10, FIG. 10 is a schematic diagram of an automated web application development system 1000 in an embodiment of the disclosed subject matter. In an exemplary embodiment, the automated web application development system 1000 comprises a chat module 1005, a web server 1010, a client device 1015, and a generative AI system 1030.

The chat module 1005 is an Artificial Intelligence (AI) enabled chatbot or voice bot that can interact with a client associated with the client device 1015 using a user console provided by the web server 1010. The chat module 1005 is capable of having an automated conversation with the client. Initially, the client logs in to the web server 1010 using the client device 1015. Upon providing the login details and entering the user console provided by the web server 1010, the user can be provided with a default web page front end 1025 on the client device 1015. The default web page front end 1025 comprises a default web application and an interface to interact with the chat module 1005, where the interface is empowered using a chat orchestrator 1020. The chat orchestrator 1020 enables seamless coordination and conversation between the user and the chat module 1005, ensuring smooth transitions and a cohesive user experience. The chat orchestrator 1020 intelligently routes the conversation, manages context, and enables efficient collaboration between the user and the chat module 1005.

Further, the chat orchestrator 1020 of the web server 1010 is in communication with the generative AI system 1030 to have efficient collaboration between the user and the chat module 1005.

Upon the user login, the chat module 1005 greets the user and starts conversation with the user. The chat module 1005 prompts the user to describe various aspects of the web application. Upon receiving the response from the user to the prompt, the chat module 1005 parses the response and extracts design elements input from the response using Natural Language Processing (NLP). In one embodiment, the design elements input may include product or service images of the web application, shop name of the web application, theme for the web application, and different colors for various designs in the web application. Further, the chat module 1005 also identifies different text elements input such as product names, brand names of the products, price of each product etc.

Upon identifying the design elements input and the text elements input, the chat orchestrator 1020 provides the design elements input and the text elements input to different modules in the generative AI system 1030. The generative AI system 1030 comprises an image and text generation system 1035, a design tokens generation system 1037, a layout editor 1040, and a feature generation system 1045. Each of the image and text generation system 1035, the design token generation system 1037, the layout editor 1040, and the feature generation system 1045 may include or be integrated with one or more generative AI tools.

The image and text generation system 1035 is triggered by the chat orchestrator 1020 using the identified design elements input received from the user. The image and text generation system 1035 includes various modules such as an image matcher 1050, an image generator 1055, and a text generator 1060. The design elements input and the text elements input are entered to each of the image matcher 1050, the image generator 1055, the text generator 1060. The image matcher 1050 is configured to retrieve a list of images from a data repository associated with the image and text generation system 1035 and match one or more images that the user intended in the design elements with the retrieved list of images. In various embodiments, the user may select one or more images from the list of images to identify the image(s) that they intended. In one implementation, the user may indicate that one of the listed images match their intended design.

When the match is found with the retrieved list of images, the one or more selected images from the retrieved list of images are recorded as images to be integrated with the web application to be developed. When the match is not found with the retrieved list of images, the image generator 1055 is configured to generate new images based on the request from the user which are recorded as images to be integrated with the web application to be developed. The text generator 1060 is configured to generate various product names, brand names, and slogans, and captions for the images based on the request from the user using the design elements.

The combination of different outputs from each of various modules of the image and text generation system 1035 creates the design elements. Further, the design tokens generation system 1037 is configured to receive the design elements from the image and text generation system 1035 and generate design tokens based on the received design elements.

The layout editor 1040 is triggered by the chat orchestrator 1020 when all the design tokens are generated. The layout editor 1040 includes a hero image editor 1070, HTML/CSS designs editor 1075, and page designs editor 1080. The hero image editor 1070 is configured to receive the design tokens from the design token generation system 1037, determine one or more hero images associated with each page of web design that is generated by the image and text generation system 1035 based on the received design tokens, and modify default hero images with the determined one or more images.

The HTML/CSS design editor 1075 is configured to receive the design tokens from the design token generation system 1037 and determine the structure and content for each web page and define one or more elements and their relationships in each web page.

The HTML/CSS design editor 1075 is further configured to generate a presentation and styling of web pages created with HTML. In one embodiment, generating a presentation and styling of web pages created with HTML comprises determining a manner in which the one or more elements should be displayed.

The page design editor 1080 is connected to the hero image editor 1070 and the HTML/CSS design editor 1075 and configured to receive an output of the hero image editor 1070 and the HTML/CSS design editor 1075 to generate a final page design for each page included in the web application being developed.

Upon receiving the response from the user to the prompt as mentioned above, the chat module 1005 is also configured to generate one or more prompts to identify a description or summary of the web application to be developed. When the user provides the response to the generated one or more prompts, the chat module 1005 is further configured to generate another set of prompts to identify one or more features input that the user intended in the web application. Alternatively, the chat module 1005 may extract the one or more features without prompting the user with the another set of prompts. Upon identifying the one or more features input, the chat module 1005 may enable the chat orchestrator to provide the one or more features input to the feature generation system 1045. The feature generation system 1045 includes a feature editor 1085, feature templates 1090 having default features 1095 associated with each of the feature templates 1090, and a feature linkage predictor 1099. The feature editor 1085, upon receiving the one or more features input, is configured to identify a most likely matching feature template from the feature template and determines the one or more features that need to be customized in the feature template to meet the requirements of the user. In one embodiment, the most likely matching feature template is determined by matching one of the one or more features inputs or a description/summary of the web application to be developed. Upon determining the one or more features, the feature editor 1085 is configured to generate the one or more features and pass the same to the feature linkage predictor 1099. The feature linkage predictor 1099 is configured to receive the generated one or more features and predict the best possible linkage between the generated one or more features.

Upon the best possible linkage between the generated one or more features is predicted, the feature generation system 1045 is configured to provide the information of the one or more features along with the linkage information to the layout editor. The layout editor 1040 may call the page design editor 1080 to generate a web application design by creating one or more features in one or more pages of the software application.

Upon the page design editor 1080 modifying the design of the web application based on the prompt from the user as mentioned above, the web page front end 1025 may display a new web design simultaneously so as to have a seamless experience for the user.

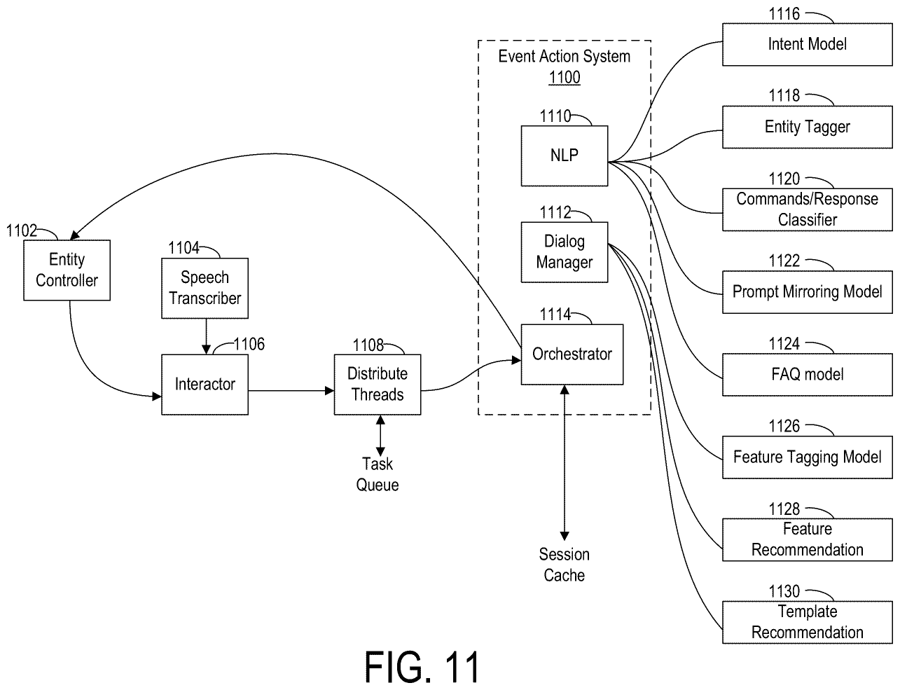

Referring to FIG. 11, FIG. 11 is a schematic for an event action system 1100 to interact and generate content responsive to automated communication in an embodiment of the disclosed subject matter. The event action system 1100 may be used to generate or modify content, instructions, plans, or the like in real time based on an interactive communication between a real person and an automated system. In various embodiments, an individual may interact with the event action system 1100 to build or modify various digital content such as a webpage, software application, various features of the software application, create and edit various art such as images or 3D models, interact with third-party APIs, and the like.

The event action system 1100 may be configured to interact with a user based on a back-and-forth communication with a user. In various embodiments, the back-and-forth communication may be between a user and an automated system. The back-and-forth communication may be digitized by a speech transcriber 1104 and transmitted to the interactor 1106. The interactor 1106 may then transmit an output of a back-and-forth communication to a thread distribution component 1108 that splits the output into one or more tasks that are transmitted to an orchestrator 1114 of the event action system 1100. The orchestrator 1114 may cause the event action system 1100 to return one or more outputs based on each task whereby output is transmitted to the entity controller 1102.

The event action system 1100 includes a natural language processing (NLP) module 1110, a dialogue manager 1112, and the orchestrator 1114. The NLP module 1110 returns an output based on an analysis of a communication. In the embodiment of the NLP module 1110 shown in FIG. 11, the NLP module 1110 includes a multitude of models that return an output based on a communication. For example, a model of the NLP module 1110 may return a response (if any) based on an interaction between an automated system and a user. For instance, a user may affect the automated system how long the interaction will take. The various other models of the NLP module 1110 may cause the event action system 1100 to respond to the question in different ways based on the output of the original model. In various embodiments, one or more models may be configured to return response based on a response from another model.

In an exemplary embodiment, the models include an intent model 1116, entity tagger 1118, a command/response classifier 1120, a prompt mirroring model 1122, and an FAQ model. Each of the models may be a machine learning algorithm that is trained to return a specific type of response based on a communication. For example, the intent model 1116 may be trained to return an intent of one or more entities that are taking part in the communication. The term “intent” as used herein refers to a desired outcome of the communication. For example, a user may request to include a feature in a software application. The intent model 1116 may return a machine-readable output that the feature should be included in the software application. In more specific example, a user may request that a software application have a feature allowing customers to login. The intent model 1116 may return that the software application should have a feature that authenticates users by a username and password.

The entity tagger 1118 determines an element in an HTML document. For example, where a user wishes to edit a webpage, the user may specify that an image should be changed. The entity tagger 1118 may analyze a communication to determine to which HTML element in the webpage the user is referring. Another module may act upon the response from the entity tagger 1118 to modify the image based on the user's wishes as determined by the intent model 1116.

The command/response classifier 1120 determines an appropriate action that the events action system 1100 should take in response to a communication. For example, the command/response classifier 1120 may return that the event action system 1100 should answer a users question with a text. In another example, the command/response classifier 1120 may return that the event action system 1100 should perform an action such as modifying or editing an image that is displayed to a user. And in another example, the command/response classifier 1120 may return that the event action system 1100 should both provide a text response and perform an action based on a communication from a user. In various embodiments, the commander/response classifier 1120 passes on an output to other NLP models for further processing.

In an exemplary embodiment where the automated system suggests prompts to one or more participants in a chat, the prompt mirroring model 1122 may provide suggested prompts. The prompt mirroring model 1122 may further determine when the prompt has been mirrored. The term “mirrored” as used herein, refers to the process of repeating a portion of a prompt that was provided by the automated system. In various embodiments, the mirroring may comprise repeating a paraphrased version of the prompt. The prompt mirroring model 1122 may be configured to determine a communication is a paraphrased version of a prompt.

In an exemplary embodiment where a second automated system is communicating with a user, the second automated system may mirror a prompt that is returned by the first automated system. The first automated system may generate prompts whereby the second automated system generates a communication based on the generated prompt. The first automated system may record the chat communication between the second automated system and the user to generate further prompts. Accordingly, the second automated system may act to refine, check for errors, or generally enhance the prompts of the first automated system for communication.

The FAQ model 1124 returns an output response to questions asked by user. The FAQ model 1124 may be trained based on questions that are frequently asked in order to give appropriate responses. In an exemplary embodiment, the FAQ model 1124 may be implemented to determine an appropriate response after the command/response classifier 1120 returns that the event action system 1100 should provide a text response to a user's question.

The dialogue manager 1112 outputs responses and actions based on a dialogue with a user. The term “dialogue” as used herein refers to a back-and-forth communication between 2 or more entities. The back-and-forth communication may be performed during a single session or multiple sessions. The dialogue manager 1112 includes a feature tagging model 1126, a feature recommendation component 1128, and a template recommendation component 1130.

The dialogue manager 1112 may provide direction for a communication based on an entirety of a dialogue. For example, the dialogue manager may determine based on multiple back-and-forth messages that a feature or template should be recommended to the user. Accordingly, the dialogue manager 1112 would output a recommendation for the feature or template. The feature tagging model 1126 determines an HTML element to create, edit, or otherwise modify. For example, the feature tagging model may determine that a size of an HTML document should be modified. Accordingly, the feature tagging model would return a tag that defines the size of the HTML document. In various embodiments, the feature tagging model 1126 may return an output based on one or more outputs of the entity tagger 1118.

The feature recommendation component 1128 may provide one or more recommendations to a user based on a back-and-forth communication with the user. In various embodiments, the feature recommendation component 1128 may be trained based on features that were recommended and accepted by users of previous sessions. For example, the dialogue manager 1112 may determine based on an entirety of a back-and-forth communication that is likely that a user may wish to have a feature or a shopping application that allows a customer to scroll through a list of products or services in order to browse through them. The dialogue manager 1112 may return a feature recommendation that would enable this functionality.

The template recommendation component 1130 may output a template recommendation for a user. The template may refer to an organization of features for a software application. For example, a user may describe an application for delivering products or services that is similar to the functionality of Uber or Lyft. Based on the back-and-forth communication, the template recommendation component 1130 may output a template for an Uber-style application. The user may have the option to accept or reject any of the recommendations made by the dialogue manager 1112. Once accepted, features or templates may be further modified by the event action system 1100 based on communication with the user.

The orchestrator 1114 may output one or more commands that cause the entity controller 1102 to perform an action based on output from the NLP module 1110 and/or dialogue manager 1112. For example, the orchestrator 1114 may output an instruction that causes the entity controller 1102 to begin development of a software application that the user requested during a back-and-forth communication. In various embodiments, the orchestrator 1114 may output a command to determine a cost to develop a software application based on features or templates selected by a user. The entity controller 1102 may determine a cost and feed the cost back to the interactor 1106.

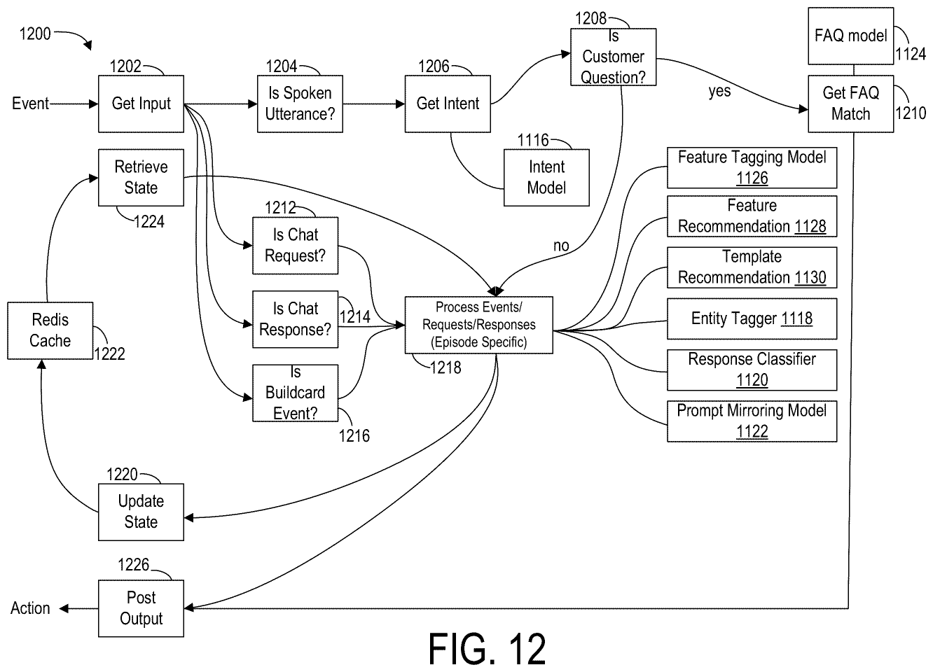

Referring to FIG. 12, FIG. 12 is flow diagram 1200 showing a process performed by the event action system 1100 according to one embodiment of the instant disclosure. By using this process, the system can interact with a client user and generate content based on the interaction, all in an automated manner. For example, the system can generate a design for a software application in real time based on automated communication with the client user.

In step 1202, the event action system 1100 receives an input from the client user. In step 1204, the system determines whether the input is a spoken utterance. In step 1212, the system determines whether the input is a request submitted via the chat module 1005. In step 1214, the system determines whether the input is a response submitted via the chat module 1005. In step 1216, the system determines whether the input is an event for creating a written specification for the software application (e.g., a buildcard).

If the input is determined to be a spoken utterance in step 1204, the event action system 1100 obtains the intent of the client user in step 1206 by using the intent classifier module 1116. In step 1208, the system determines whether the client user has asked a question. If the answer is yes, then the system obtains a FAQ match in step 1210 by using the FAQ model 1124. The system then outputs the answer to the client user in step 1226.

If the answer is no, or if it is determined in steps 1212, 1214, and 1216 that the input is a chat request, chat response, or a buildcard event, then the process moves to step 1218. In step 1218, the event action system 1100 processes requests, responses, and events according to the specific episode. The processing step 1218 is performed using at least one the feature tagging model 1126, the feature recommendation 1128, the template recommendation 1130, the entity tagger 1118, the response classifier 1120, and the prompt mirroring model 1122. As mentioned previously, each of these models may be a machine learning algorithm that is trained to return a specific type of response based on a communication.

In step 1226, the system outputs content to the client user based on the processed information. This content could include, for example, a prototype of a software application. In step 1220, the system updates the current state of the processed information and caches this state in step 1222. For instance, the system can update the current design elements of a software application and store these design elements for later usage. The system can then access this information in step 1224 and use it in step 1218 to process further events, requests, or responses received from the client user. For example, the system can modify or add additional design elements to a prototype based on further interaction with the client user.

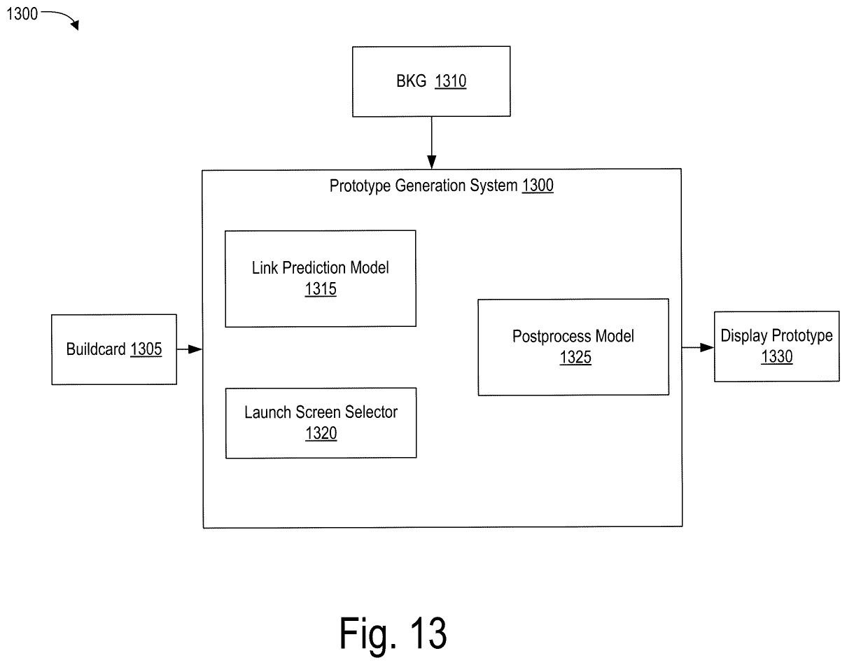

Referring to FIG. 13, FIG. 13 is a schematic for an embodiment of a prototype generation system 1300 of the disclosed subject matter. The prototype generation system 1300 facilitates the generation of software application prototype based on input from a buildcard 1305 and a Builder Knowledge Graph (BKG) 1315.

The information provided by a customer to develop the software application is converted into a machine-readable specifications. The machine-readable specification may be referred to herein as the buildcard 1305. The buildcard 1305 includes one or more features selected by a customer to develop the software application. In one example, the one or more features can be a login feature, a sign up feature, a payment processing feature, and so on. The buildcard 1305 also includes application information selected by a customer to develop the software application. The application information is also known as application template which gives the information about a design of the software application (or) an interface of the software application. In one embodiment, the application template can be a custom template when the user provides his/her inputs for the design different from existing software applications. In another embodiment, the application template can be a pre-defined template taken from the existing software application. For example, if the customer wants to develop a software application related to an e-commerce platform, the customer can make a selection template or design similar to one of the popular e-commerce platforms available. The buildcard 1305 also includes a cost and/or timeline required for the software development based on the one or more features and the application information.

The builder knowledge graph (BKG) 1310 includes a database based on information from one or more historical projects developed and the information fed by one or more users/admins of the BKG 1310. In one embodiment, the database can be a graph database that stores nodes and relationships instead of tables or documents. In one example, the nodes can be features, and the relationships can be linkage between the features. In another embodiment, the database can be a traditional database that stores data in tables or documents. The database also includes master templates, master feature images, one or more historical buildcards, one or more historical buildcard feature images, one or more historical buildcard features, one or more historical buildcard hotspots, one or more clickable items, application details, and so on.

The prototype generation system 1300 includes one or more blocks or modules known as a link prediction module 1315, a launch screen selector 1320, and a postprocess module 1325. As user herein, the term module refers to an application-specific integrated circuit (ASIC), an electronic circuit, a processor (shared, dedicated, or group) and memory that execute one or more software or firmware programs, a combination logic circuit, and/or other suitable components that provide the described functionality.

The link prediction module 1315 is configured to receive one or more features and an application template selected by the customer from the buildcard 1305. The link prediction module 1315 is configured to estimate a linkage between each pair of features of the one or more features. In order to estimate the linkage between each pair of features, the link prediction module 1315 is configured to initially retrieve the historical data from the database coupled to the BKG 1310. Upon retrieving the historical data, the link prediction module 1315 is configured to select an appropriate machine learning model from a plurality of machine learning models. In one embodiment, the machine learning model can be a variant of Light Gradient Boosting (LGB) model. The link predication module 1315 is then configured to input the historical data and each pair of features along with additional inputs to the selected machine learning model. Based on an output of the selected machine learning model, the link prediction module 1315 is configured to estimate the linkage between each pair of features. In one embodiment, in order to select the machine learning model, the link prediction module 1315 is configured to input one or more inputs and the retrieved data to each of the plurality of machine learning model by assigning a weightage factor to each of the one or more inputs. Further, the link prediction module 1315 is configured to determine values of one or more output parameters, wherein at least one parameter of the one or more output parameters includes an F1 score. Based on one or more output parameter values, the link prediction module 1315 selects the machine learning model for estimating the linkage. In one embodiment, the one or more inputs can be the application template, the one or more features, a probability of correlation between a pair of features, and an existence of relationship between each pair of features in the database. In one embodiment, the existence of relationship between each pair of features may be stored in Content Management System also known as CMS.

The launch screen selector 1320 is coupled to the link prediction model 1315. The launch screen selector 1320 is configured to recommend and/or select one or more launch screens or a start screen feature for the application. In order to recommend and/or select the one or more launch screens or the start screen feature for the application, the launch screen selector 1320 is configured to receive a hierarchical relationship between the one or more features from the link prediction module 1315.

In one embodiment, in order to recommend the one or more launch screens for the application, the launch screen selector 1320 is configured to identify a type of application based on the application template. In one example, the type of application can be financial, e-commerce, entertainment, e-learning, and so on. Upon identifying the type of application, the launch screen selector 1320 is configured to input the type of application and the one or more features to a first machine learning model and recommend the one or more launch screens for the application based on an output of the first machine learning model.

In one embodiment, to recommend the one or more launch screens for the application, the launch screen selector 1320 is configured to extract one or more launch screens selected for historical applications, wherein the historical applications are selected based on the application template. Upon extracting one or more launch screens selected for historical applications, the launch screen selector 1320 is configured to compare the features with selected one or more launch screens and recommend the one or more launch screens for the application based on the comparison.

In one embodiment, to recommend the one or more launch screens for the application, the launch screen selector 1320 is configured to extract keywords for one or more launch screens selected for historical applications, wherein the historical applications are selected based on the application template. Upon extracting the keywords for the one or more launch screens selected for historical applications, the launch screen selector 1320 is configured to compare the features with selected one or more launch screens and recommend the one or more launch screens for the application based on the comparison.

The postprocess module 1325 is coupled to the link prediction module 1315 and the launch screen selector 1320. The postprocess module 1325 is configured to process the one or more selected features based on the determined linkage from the link prediction model. In one embodiment, the step of processing the one or more selected features based on the determined linkage by the post process model includes classifying the one or more features as unconnected features and connected features. Further, the step of processing also includes identifying one or more potential hotspots in the one or more unconnected features and predicting the linkage for the one or more unconnected features with the connected features based on the one or more identified potential hotspots.

In one embodiment, in order to predict the linkage for the one or more unconnected features, the postprocess module 1325 is configured to retrieve one or more clickable items mapped to the identified one or more potential hotspots, wherein the one or more clickable items are included in the one or more features and predict the linkage for the one or more unconnected features with the connected features based on the retrieved one or more clickable items.

In one embodiment, in order to predict the linkage for the one or more unconnected features, the postprocess module 1325 is configured to input the identified one or more potential hotspots to a first machine learning model and estimate one or more clickable items as an output of the first machine learning model, wherein the one or more clickable items are included in the one or more features. The postprocess module 1325 is then configured to predict the linkage for the one or more unconnected features with the connected features based on the estimated one or more clickable items.

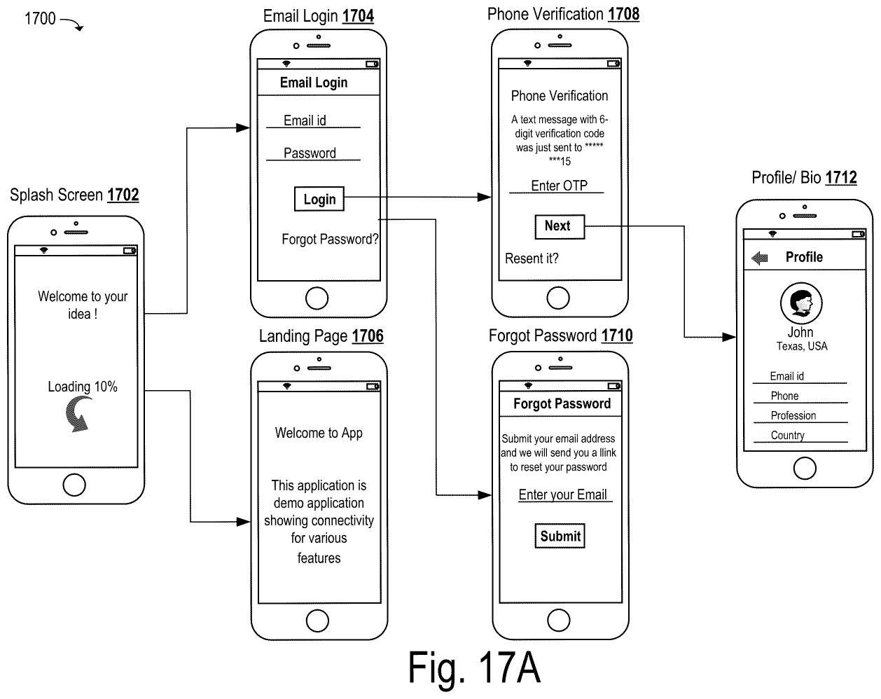

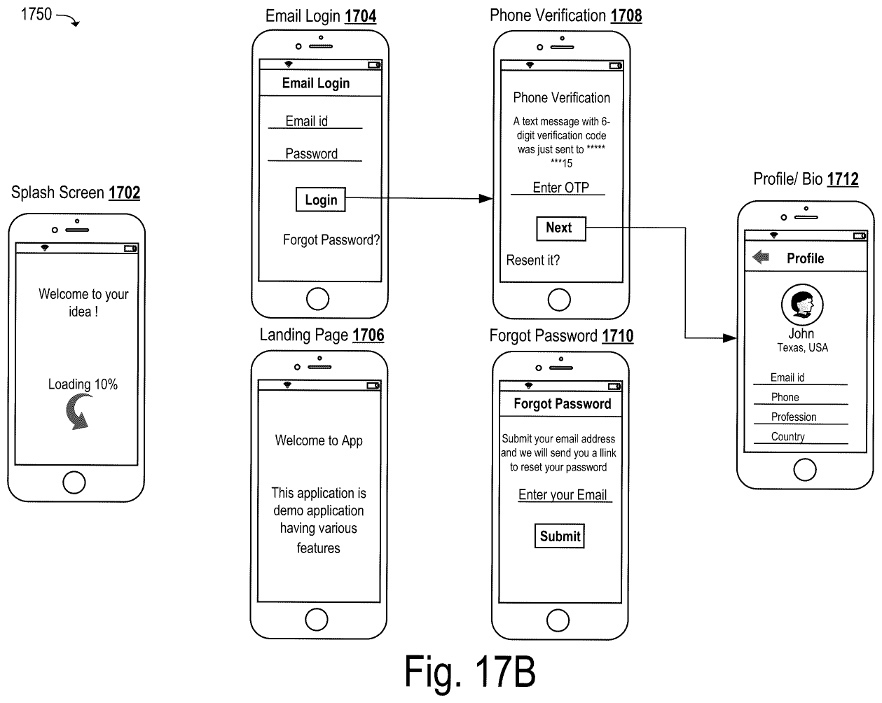

The display prototype 1330 is coupled to an output of the prototype generation system 1300. The Display prototype 1330 generates the prototype and display the generated prototype of the software application to be developed. In one embodiment, the prototype of the software application is generated and displayed as a flow of screens connected as per the estimated linkages as shown in FIG. 17A. In another embodiment, the prototype of the software application is displayed as a graph having nodes as features and relationship between nodes as the linkage between the features as shown in 19A.

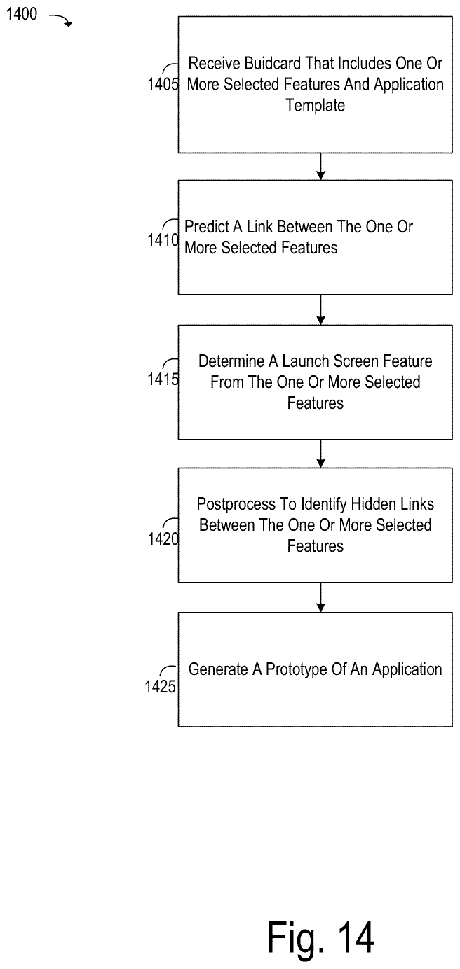

Referring to FIG. 14, FIG. 14 is a flow diagram 1400 for an embodiment of a process of generating a prototype of an application. The process may be utilized by one or more modules in the prototype generation system 1300 for generating the prototype of an application. The order in which the process/method 1400 is described is not intended to be construed as a limitation, and any number of the described method blocks can be combined in any order to implement the method 700. Additionally, individual blocks may be deleted from the method 1400 without departing from the spirit and scope of the subject matter described herein. Furthermore, the method 1400 can be implemented in any suitable hardware, software, firmware, or combination thereof.

At step 1405, the process may receive the buildcard. The buildcard 1305 includes one or more features selected by the customer for the development of the software application. In one example, the one or more features can be a login feature, a sign up feature, a payment processing feature, and so on. The buildcard 1305 also includes application information selected by a customer for the development of the software application. The application information is also known as application template which gives the information about a design of the software application (or) an interface of the software application. In one embodiment, the application template can be a custom template when the user provides his/her inputs for the design which is different from already existing software applications. In other embodiment, the application template can be a pre-defined template taken from the already existing software application. For example, if the customer wants to develop a software application related to e-commerce platform, the customer can make a selection of a template or design similar to one of the popular e-commerce platforms available. The buildcard 1305 also includes a cost and/or timeline required for the software development based on the one or more features and the application information.

At step 1410, the process may predict a link between the one or more selected features. The link prediction module 1315 is configured to receive one or more features and an application template selected by the customer from the buildcard 1305. The link prediction module 1315 is configured to estimate a linkage between each pair of features of the one or more features. In order to estimate the linkage between each pair of features, the link prediction module 1315 is configured to initially retrieve the historical data from the database coupled to the BKG 1310. Upon retrieving the historical data, the link prediction module 1315 is configured to select an appropriate machine learning model from a plurality of machine learning models. In one embodiment, the machine learning model can be a variant of Light Gradient Boosting (LGB) model. The link predication module 1315 is then configured to input the historical data and each pair of features to the selected machine learning model. Based on the output of the selected machine learning model, the link prediction module 1315 is configured to estimate the linkage between each pair of features. In one embodiment, in order to select the machine learning model, the link prediction module 1315 is configured to input one or more inputs and the retrieved data to each of the plurality of machine learning model by assigning a weightage factor to each of the one or more inputs. Further, the link prediction module 1315 is configured to determine a value of one or more parameters, wherein at least parameter of the one or more parameters includes a F1 score; and select the machine learning model based on the value of the one or more parameters for estimating the linkage. In one embodiment, the one or more inputs can be the application template, the one or more features, a probability of correlation between a pair of features, and the determined existence of relationship between the pair of features.

At step 1415, the process may determine one or more launch screen features from the one or more selected features. The launch screen selector 1320 is coupled to the link prediction model 1315. The launch screen selector 1320 is configured to recommend and/or select one or more launch screen or a start screen feature for the application. In order to recommend and/or select one or more launch screen or a start screen feature for the application, the launch screen selector is configured to receive a hierarchical relationship between the one or more features from the link prediction model. In one embodiment, to recommend the one or more launch screen for the application, the launch screen selector 1320 is configured identify a type of application based on the application template. In one example, the type of application can be financial application, e-commerce application, entertainment application, and e-learning application. Upon identifying the type of application, the launch screen selector 1320 is configured to input the type of application and the one or more features to a first machine learning model and recommend the one or more launch screens for the application based on an output of the first machine learning model. model. In one embodiment, in order to recommend the one or more launch screen for the application, the launch screen selector 1320 is configured extract one or more launch screens selected for historical applications, wherein the historical applications are selected based on the application template. Upon extracting one or more launch screens selected for historical applications, the launch screen selector 1320 is configured to compare the one or more features with selected one or more launch screens and recommend the one or more launch screen for the application based on the comparison. In one embodiment, in order to recommend the one or more launch screen for the application, the launch screen selector 1320 is configured extract keywords for one or more launch screens selected for historical applications, wherein the historical applications are selected based on the application template. Upon extracting the keywords for the one or more launch screens selected for historical applications, the launch screen selector 1320 is configured to compare the one or more features with selected one or more launch screens and recommend the one or more launch screen for the application based on the comparison.

At step 1420, the process may identify one or more hidden links between the selected features. In one embodiment, the postprocess module 1325 is configured to process the one or more selected features based on the determined linkage from the link prediction module 1315. In one embodiment, the step of processing the one or more selected features based on the determined linkage by the postprocess module 1325 includes classifying the one or more features as unconnected features and connected features. Further, the step of processing also includes identifying one or more potential hotspots in the one or more unconnected features and predicting the linkage for the one or more unconnected features with the one or more features based on the one or more identified potential hotspots. In one embodiment, in order to predict the linkage for the one or more unconnected features, the postprocess module 1325 is configured to retrieve one or more clickable items mapped to the identified one or more potential hotspots, wherein the one or more clickable items are included in the one or more features and predict the linkage for the one or more unconnected features with the one or more features based on the retrieved one or more clickable items. In one embodiment, in order to predict the linkage for the one or more unconnected features, the postprocess module 1325 is configured to input the identified one or more potential hotspots to a first machine learning model and estimate one or more clickable items as an output of the first machine learning model, wherein the one or more clickable items are included in the one or more features. The postprocess module 1325 is then configured to predict the linkage for the one or more unconnected features with the one or more features based on the estimated one or more clickable items.

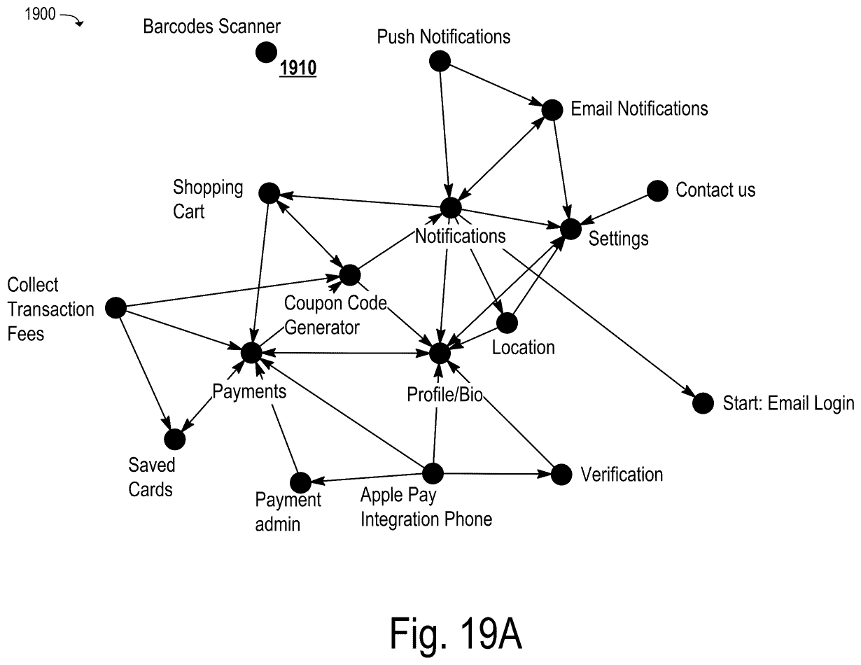

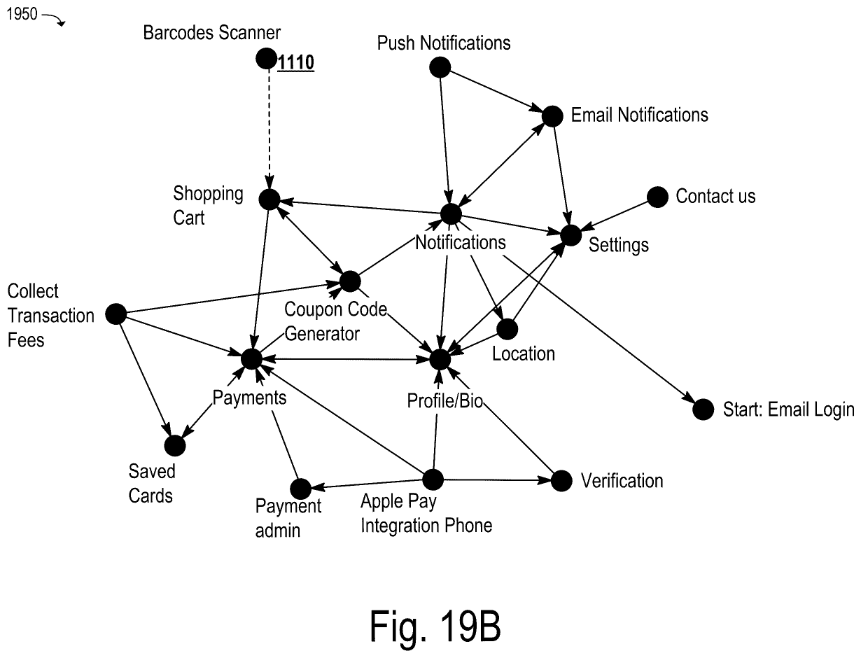

At step 1425, the process may generate the prototype of the application using an output of the postprocess module 1325. In one embodiment, the prototype of the software application is generated and displayed as a flow of screens connected as per the estimated linkages shown in FIG. 17A. In another embodiment, the prototype of the software application is displayed as a graph having nodes as features and relationship between the nodes as a linkage as shown in FIG. 19A.

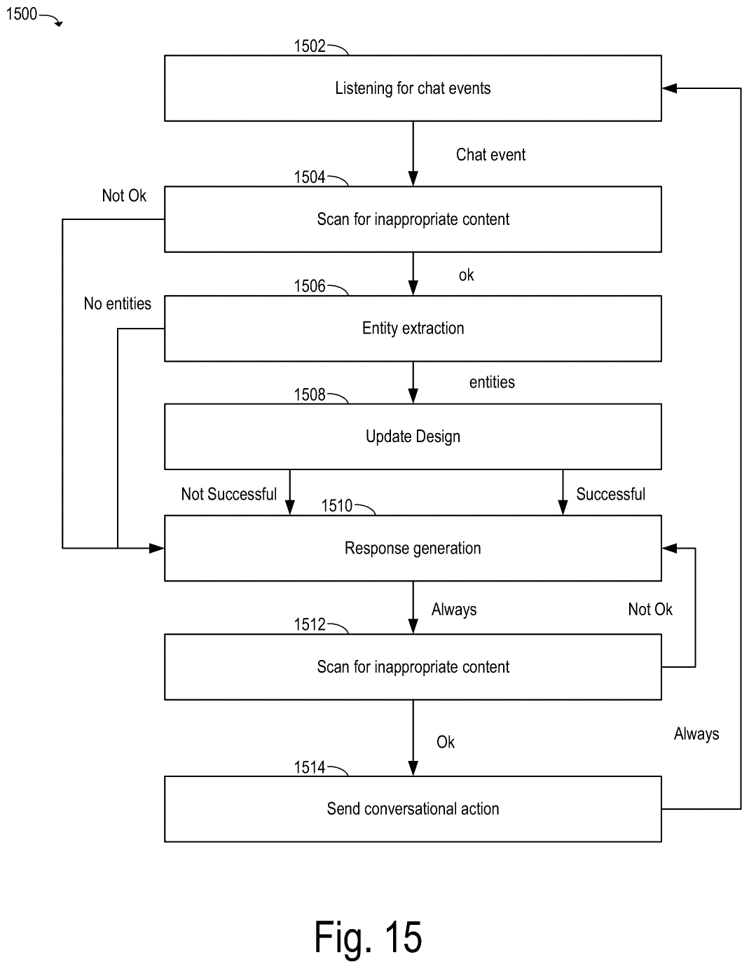

Referring to FIG. 15, FIG. 15 is a flow diagram for a process 1500 for generating a response to chat interaction by an automated system. The automated system may implement the process to communicate back and forth with one or more users and generate content based on the communication. In an exemplary embodiment, an automated system may communicate with a user wishes to instruct the audit system to generate a software application. In various embodiments, automated system may communicate with the user to generate one or more features of a social occasion. In various embodiments, the automated system may generate one or more features to be appended to a template for a software application.

At step 1502 of the process 1500, the automated system may listen for chat events. A chat event may be a communication that is received by the automated system. An example of a chat event may be a text message, email message, audio message, image message, video message, or any other message that may be transmitted to the automated system.

At step 1504 of the process 1500, the automated system may scan the chat event for inappropriate content. The term “inappropriate content” as used herein, may refer to a request to generate any text, image, video, color, template, or the like for which the system is not allowed to generate. An example of inappropriate content may be copyrighted material. For example, a user may request to insert a video clip from a copyrighted performance. The system may determine that the request for copyrighted material is a request for inappropriate content. In various embodiments, the inappropriate content may be content for which the automated system is incapable of generating. For example, a user may request that the system generate a detailed image of a human face that includes difficult to render details such as reflections in the human eyes and subsurface scattering in the human skin that the trays dimples and subsurface colors. The automated system may determine that the request is not possible to perform and flag the request is inappropriate content.

At step 1506 of the process 1500, the automated system may generate one or more entities based on the communication. The term entity, as used for step 1506, may refer to an element, feature, or other content that may be inserted or appended to a software application. In an exemplary embodiment, the automated system may generate content using the event action system 1100. In an example, the automated system may determine or generate one or more images to be inserted into a software application. For example, a user may specify that a webpage should have a certain type of image. The automated system may determine one or more images that fit the user's description. In various embodiments, the automated system may display the one or more images to the user. In an exemplary embodiment, the automated system may prompt the user to select the determined image that is most satisfactory.

At step 1508 of the process 1500, the automated system may update a design, feature, or specification with the entity that would determine are generated at step 1506.

At step 1510 of the process 1500, automated system may generate a response for the user. If the automated system is able to successfully update the design at step 1508, the response at step 1510 may be to send the user a confirmation of the updated design. Likewise, the automated system may inform the user that the design cannot be updated if the update at step 1508 was unsuccessful. The response may also be generated at step 1510 if there are no entities to extract at step 1506 or if the automated system determined that there was inappropriate content at step 1504.

At step 1512 of the process 1500, the automated system may scan the generator response at step 1510 for inappropriate content. Automated system may set arbitrary rules for content that is inappropriate. For example, the automated system may limit a size of video or images that may be generated for the software application and flag any content that exceeds the limit as inappropriate. The automated system may flag any content as inappropriate that may result a cost that exceeds the threshold. For example, a user may request a feature that, if implemented, would cause the cost of developing the software application to exceed a threshold. The automated system could flag the requested feature as inappropriate. If the automated system does determine a response to be inappropriate, the automated system may generate a new response at step 1510.

At step 1514 of the process 1500, the automated system may send a conversational action. For example, automated system may send the response that was generated at step 1510 to the user. Additionally, the automated system may implement step 1502 and listen for additional chat events.

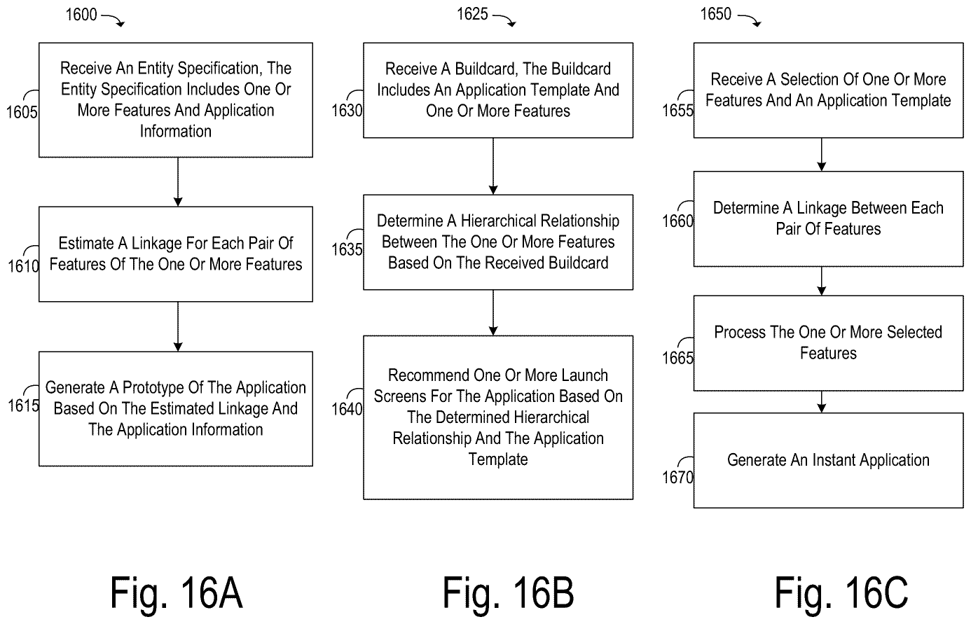

Referring to FIG. 16A, FIG. 16A is a flow diagram 1600 for an embodiment of a process of generating a prototype of an application. The process may be utilized by one or more modules in the prototype generation system 1300 for generating the prototype of an application. The order in which the process/method 1600 is described is not intended to be construed as a limitation, and any number of the described method blocks can be combined in any order to implement the method 1600. Additionally, individual blocks may be deleted from the method 1600 without departing from the spirit and scope of the subject matter described herein. Furthermore, the method 1600 can be implemented in any suitable hardware, software, firmware, or combination thereof.

At step 1605, the process may receive an entity specification. The entity specification includes one or more features selected by a customer for the development of the software application. In one example, the one or more features can be a login feature, a sign up feature, a payment processing feature, and so on. The entity specification also includes application information selected by a customer for the development of the software application. The application information is also known as application template which gives the information about a design of the software application (or) an interface of the software application. In one embodiment, the application template can be a custom template when the user provides his/her inputs for the design which is different from already existing software applications. In other embodiment, the application template can be a pre-defined template taken from the already existing software application. For example, if the customer wants to develop an software application related to e-commerce platform, the customer can make a selection template or design similar to one of the popular e-commerce platforms available. The entity specification also includes a cost and/or timeline required for the software development based on the one or more features and the application information.

At step 1610, the process may predict a link between the one or more selected features. The link prediction module 1315 is configured to receive one or more features and an application template selected by the customer from the buildcard 1305. The link prediction module 1315 is configured to estimate a linkage between each pair of features of the one or more features. In order to estimate the linkage between each pair of features, the link prediction module 1315 is configured to initially retrieve the historical data from the database coupled to the BKG 1310. Upon retrieving the historical data, the link prediction module 1315 is configured to select an appropriate machine learning model from a plurality of machine learning models. In one embodiment, the machine learning model can be a variant of Light Gradient Boosting (LGB) model. The link predication module 1315 is then configured to input the historical data and each pair of features to the selected machine learning model. Based on the output of the selected machine learning model, the link prediction module 1315 is configured to estimate the linkage between each pair of features. In one embodiment, in order to select the machine learning model, the link prediction model is configured to input one or more inputs and the retrieved data to each of the plurality of machine learning model by assigning a weightage factor to each of the one or more inputs. Further, the link prediction module 1315 is configured to determine a value of one or more parameters, wherein at least parameter of the one or more parameters includes a F1 score; and select the machine learning model based on the value of the one or more parameters for estimating the linkage. In one embodiment, the one or more inputs can be the application template, the one or more features, a probability of correlation between a pair of features, and the determined existence of relationship between the pair of features.

At step 1615, the process may generate a prototype of an application using an output of the link prediction module 1315. In one embodiment, the prototype of the software application is generated and displayed as a flow of screens connected as per the estimated linkages shown in FIG. 17A. In another embodiment, the prototype of the software application is displayed as a graph having nodes as a features and relationship between the nodes as a linkage as shown in FIG. 19A.

Referring to FIG. 16B, FIG. 16B is a flow diagram 1625 for an embodiment of a process of recommending one or more launch screens for the application. The process may be utilized by one or more modules in the prototype generation system 1300 for generating the prototype of an application. The order in which the process/method 1625 is described is not intended to be construed as a limitation, and any number of the described method blocks can be combined in any order to implement the method 1625. Additionally, individual blocks may be deleted from the method 1625 without departing from the spirit and scope of the subject matter described herein. Furthermore, the method 1625 can be implemented in any suitable hardware, software, firmware, or combination thereof.

At step 1630, the process may receive a buildcard. The buildcard 1305 includes one or more features selected by a customer for the development of the software application. In one example, the one or more features can be a login feature, a sign up feature, a payment processing feature, and so on. The buildcard 1305 also includes application information selected by a customer for the development of the software application. The application information is also known as application template which gives the information about a design of the software application (or) an interface of the software application. In one embodiment, the application template can be a custom template when the user provides his/her inputs for the design which is different from already existing software applications. In other embodiment, the application template can be a pre-defined template taken from the already existing software application. For example, if the customer wants to develop an software application related to e-commerce platform, the customer can make a selection template or design similar to one of the popular e-commerce platforms available. The buildcard 1305 also includes a cost and/or timeline required for the software development based on the one or more features and the application information.

At step 1635, the process may determine a hierarchal relationship between the one or more selected features. The link prediction module 1315 is configured to receive one or more features and an application template selected by the customer from the buildcard 1305. The link prediction module 1315 is configured to determine a linkage between each pair of features of the one or more features. In order to determine the linkage between each pair of features, the link prediction module 1315 is configured to initially retrieve the historical data from the database coupled to the BKG 1310. Upon retrieving the historical data, the link prediction module 1315 is configured to select an appropriate machine learning model from a plurality of machine learning models. In one embodiment, the machine learning model can be a variant of Light Gradient Boosting (LGB) model. The link predication module 1315 is then configured to input the historical data and each pair of features to the selected machine learning model. Based on the output of the selected machine learning model, the link prediction module 1315 is configured to estimate the linkage between each pair of features. In one embodiment, in order to select the machine learning model, the link prediction module 1315 is configured to input one or more inputs and the retrieved data to each of the plurality of machine learning model by assigning a weightage factor to each of the one or more inputs. Further, the link prediction module 1315 is configured to determine a value of one or more parameters, wherein at least parameter of the one or more parameters includes a F1 score; and select the machine learning model based on the value of the one or more parameters for estimating the linkage. In one embodiment, the one or more inputs can be the application template, the one or more features, a probability of correlation between a pair of features, and the determined existence of relationship between the pair of features.

At step 1640, the process may recommend one or more launch screen features from the one or more selected features. The launch screen selector 1320 is coupled to the link prediction model 1315. The launch screen selector 1320 is configured to recommend and/or select one or more launch screens or a start screen feature for the application. In order to recommend and/or select one or more launch screens or a start screen feature for the application, the launch screen selector is configured to receive a hierarchical relationship between the one or more features from the link prediction model. In one embodiment, in order to recommend the one or more launch screen for the application, the launch screen selector 1320 is configured identify a type of application based on the application template. In one example, the type of application can be financial application, e-commerce application, entertainment application, and e-learning application. Upon identifying the type of application, the launch screen selector 1320 is configured to input the type of application and the one or more features to a first machine learning model and recommend the one or more launch screens for the application based on an output of the first machine learning model. model. In one embodiment, in order to recommend the one or more launch screens for the application, the launch screen selector 1320 is configured to extract one or more launch screens selected for historical applications, wherein the historical applications are selected based on the application template. Upon extracting one or more launch screens selected for historical applications, the launch screen selector 1320 is configured to compare the one or more features with selected one or more launch screens and recommend the one or more launch screens for the application based on the comparison. In one embodiment, in order to recommend the one or more launch screens for the application, the launch screen selector 1320 is configured extract keywords for one or more launch screens selected for historical applications, wherein the historical applications are selected based on the application template. Upon extracting the keywords for the one or more launch screens selected for historical applications, the launch screen selector 1320 is configured to compare the one or more features with selected one or more launch screens and recommend the one or more launch screens for the application based on the comparison.

Referring to FIG. 16C, FIG. 16C is a flow diagram 1650 for an embodiment of a process of generating an instant application. The process may be utilized by one or more modules in the prototype generation system 1300 for generating the prototype of an application. The order in which the process/method 1650 is described is not intended to be construed as a limitation, and any number of the described method blocks can be combined in any order to implement the method 1650. Additionally, individual blocks may be deleted from the method 1650 without departing from the spirit and scope of the subject matter described herein. Furthermore, the method 1650 can be implemented in any suitable hardware, software, firmware, or combination thereof.

At step 1655, the process may receive one or more features selected by a customer for the development of the software application. In one example, the one or more features can be a login feature, a sign up feature, a payment processing feature, and so on. The process also receives application information selected by a customer to develop the software application. The application information is also known as application template which gives the information about a design of the software application (or) an interface of the software application. In one embodiment, the application template can be a custom template when the user provides his/her inputs for the design which is different from already existing software applications. In other embodiment, the application template can be a pre-defined template taken from the already existing software application. For example, if the customer wants to develop a software application related to e-commerce platform, the customer can make a selection template or design similar to one of the popular e-commerce platforms available. The buildcard 1305 also includes a cost and/or timeline required for the software development based on the one or more features and the application information.

At step 1660, the process may determines a link between the one or more selected features. The link prediction module 1315 is configured to receive one or more features and an application template selected by the customer from the buildcard 1305. The link prediction module 1315 is configured to estimate a linkage between each pair of features of the one or more features. In order to estimate the linkage between each pair of features, the link prediction module 1315 is configured to initially retrieve the historical data from the database coupled to the BKG 1310. Upon retrieving the historical data, the link prediction module 1315 is configured to select an appropriate machine learning model from a plurality of machine learning models. In one embodiment, the machine learning model can be a variant of Light Gradient Boosting (LGB) model. The link predication module 1315 is then configured to input the historical data and each pair of features to the selected machine learning model. Based on the output of the selected machine learning model, the link prediction module 1315 is configured to estimate the linkage between each pair of features. In one embodiment, in order to select the machine learning model, the link prediction module 1315 is configured to input one or more inputs and the retrieved data to each of the plurality of machine learning model by assigning a weightage factor to each of the one or more inputs. Further, the link prediction module 1315 is configured to determine a value of one or more parameters, wherein at least parameter of the one or more parameters includes a F1 score; and select the machine learning model based on the value of the one or more parameters for estimating the linkage. In one embodiment, the one or more inputs can be the application template, the one or more features, a probability of correlation between a pair of features, and the determined existence of relationship between the pair of features.

At step 1665, the process may process one or more selected features to identify one or more hidden links between the selected features. In one embodiment, the postprocess module 1325 is configured to process the one or more selected features based on the determined linkage from the link prediction module 1315. In one embodiment, the step of processing the one or more selected features based on the determined linkage by the post process model includes classifying the one or more features as unconnected features and connected features. Further, the step of processing also includes identifying one or more potential hotspots in the one or more unconnected features and predicting the linkage for the one or more unconnected features with the one or more features based on the one or more identified potential hotspots. In one embodiment, in order to predict the linkage for the one or more unconnected features, the postprocess module 1325 is configured to retrieve one or more clickable items mapped to the identified one or more potential hotspots, wherein the one or more clickable items are included in the one or more features and predict the linkage for the one or more unconnected features with the one or more features based on the retrieved one or more clickable items. In one embodiment, in order to predict the linkage for the one or more unconnected features, the postprocess module 1325 is configured to input the identified one or more potential hotspots to a first machine learning model and estimate one or more clickable items as an output of the first machine learning model, wherein the one or more clickable items are included in the one or more features. The postprocess module 1325 is then configured to predict the linkage for the one or more unconnected features with the one or more features based on the estimated one or more clickable items.

At step 1670, the process may generate an instant application using an output of the postprocess module 1325. In one embodiment, the instant application is generated and displayed as a flow of screens connected as per the estimated linkages shown in FIG. 17A. In another embodiment, the instant software application is displayed as a graph having nodes as features and relationship between the nodes as a linkage between the features as shown in FIG. 19A.

Referring to FIG. 17A, FIG. 17A is an illustration of a screen flow view 1700 of an exemplary application. The screen flow view is an output of the prototype generation system 1300. The customer has selected 6 features that includes a splash screen 1702, a email login 1704, a landing page 1706, a phone verification 1708, a forgot password 1710, and a profile/bio 1712 for building an application. One or more inputs from the customer as a buildcard having 6 features and historical data from the database coupled to the BKG are provided to the prototype generation system 1300. Initially, the inputs are provided to the link prediction module 1315 of the prototype generation system 1300 to predict a linkage between each pair of the 6 features. The link prediction module 1315 initially selects a machine learning model that is required to predict the linkage between each pair of the 6 features. Upon selecting the machine learning model, the link prediction module 1315 predicts one or more linkages between the one or more features.

Once the linkage between each pair of the 45 features is identified, the inputs are processed to the launch screen selector 1320 to identify a launch screen feature or a start screen feature among the 6 features. Alternatively, the inputs are processed simultaneously by the launch screen selector 1320 along with the link prediction module 1315.

The launch screen selector based on the inputs provided selects and/or recommends the start screen feature for the application. The output from the link prediction model 1315 is then provided to the postprocess module 1325 to identify any missing linkages between the 6 features.

The output from the postprocess module 1325 includes a final linkage between the one or more features and a prototype of the application is generated using the postprocess module 1325 output. For example, the splash screen 1702 may navigate to the landing page 1706 which gives information about application. The splash screen 1702 also navigate to the email login 1704 to enter the login credentials of the user. When the user enters the login details and clicks the login button, the email login 1704 navigates to the phone verification 1708. When the clicks on forgot password, the email login 1704 navigates to the forgot password 1710. The phone verification 1708 takes inputs from the OTP received on the user's electronic device such as mobile phone. After the user enters the OTP and clicks on NEXT button, the phone verification 1708 page navigates to the profile/bio 1712. The generated prototype of the application having the screen flow view is shown in FIG. 17A.

Referring to FIG. 17B, FIG. 17B is an illustration of a subset 1750 of screen flow view of FIG. 17A. The screen flow view as shown in FIG. 17B illustrates a linkage between “Phone Verification” 1708 feature and other features such as the Email Login 1704 and the Profile/Bio 1712.

The linkage between the different features is shown by arrows connecting the different features. By selecting the Features “Phone Verification” 1708 from FIG. 17A, the linkage for the Phone Verification feature 1710 with other features is highlighted and shown as in FIG. 17B.

The linkage between the “Phone Verification” feature 1708 and other features such as the Email Login 1704 and the profile/bio 1712 is generated by one of the Link prediction module 1315 and the postprocess module 1325.

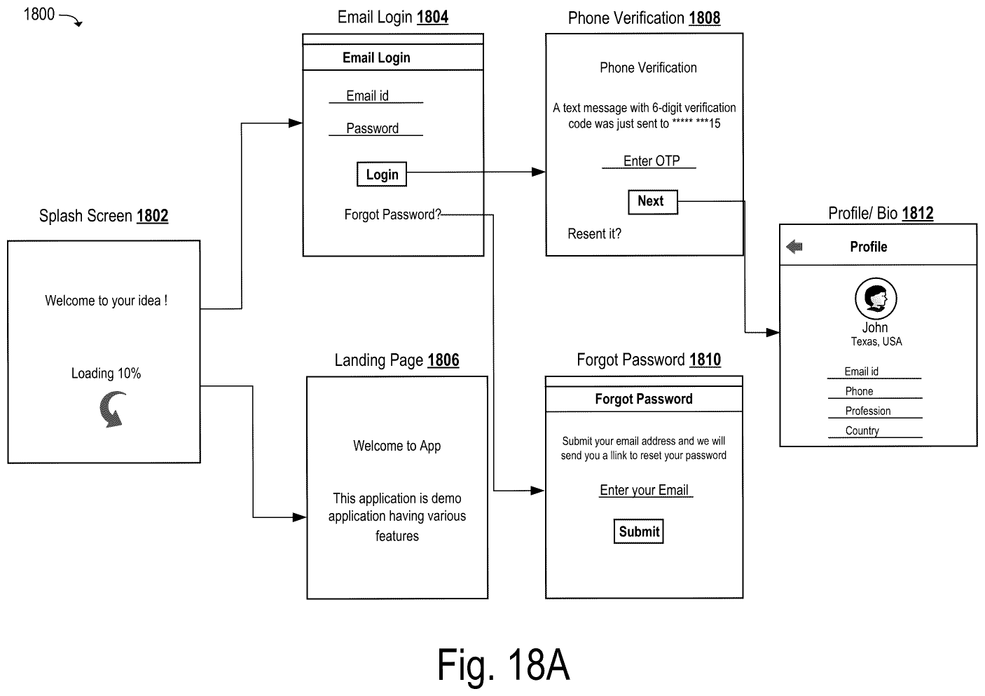

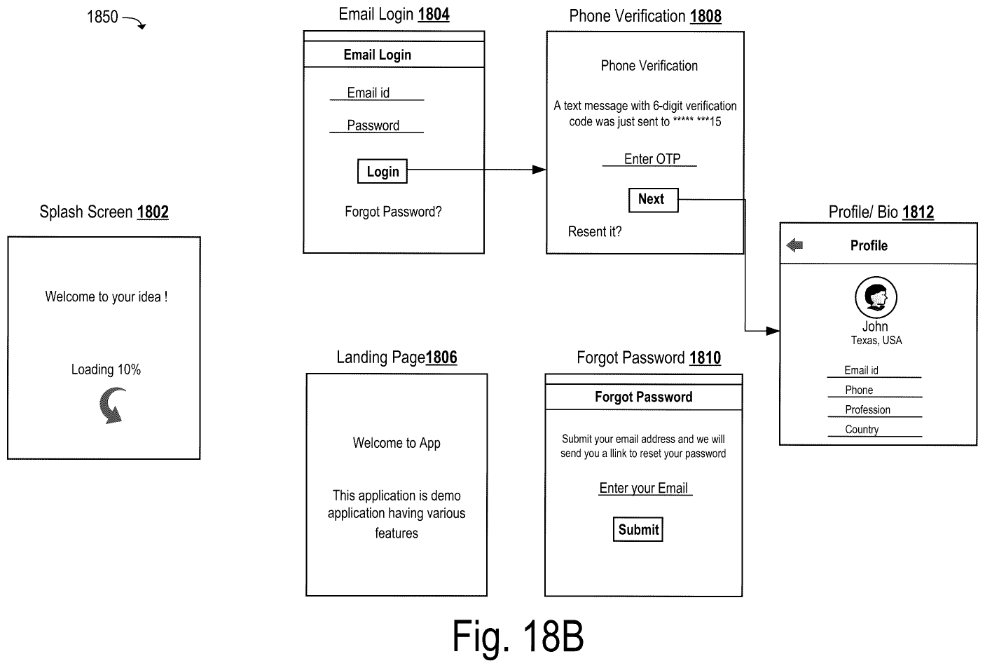

Referring to FIG. 18A, FIG. 18A is an illustration of a screen flow view 1800 of an exemplary application for the web platform. The screen flow view is an output of the prototype generation system 1300. The customer has selected 6 features such as a splash screen 1802, an email login 1804, a landing page 1806, a phone verification 1808, a forgot password 1810, and a profile/bio 1812 for building an application. One or more inputs from the customer as a buildcard having 6 features and historical data from the database coupled to the BKG are provided to the prototype generation system 1300. Initially, the inputs are provided to the link prediction module 1315 of the prototype generation system 1300 to predict a linkage between each pair of the 6 features. The link prediction module 1315 initially selects a machine learning model that is required to predict the linkage between each pair of the 6 features. Upon selecting the machine learning model, the link prediction module 1315 predicts one or more linkages between the one or more features.

Once the linkage between each pair of the 6 features is identified, the inputs are processed to the launch screen selector 1320 to identify a launch screen feature or a start screen feature among the 6 features. Alternatively, the inputs are processed simultaneously by the launch screen selector 1320 along with the link prediction module 1315.

The launch screen selector based on the inputs provided selects and/or recommends the start screen feature for the application. The output from the link prediction model 1315 is then provided to the postprocess module 1325 to identify any missing linkages between the 6 features.

The output from the postprocess module 1325 includes a final linkage between the one or more features and a prototype of the application is generated using the postprocess module 1325 output. For example, the splash screen 1802 may navigate to the landing page 1806 which gives information about application. The splash screen 1802 also navigate to the email login 1804 to enter the login credentials of the user. When the user enters the login details and clicks the login button, the email login 1804 navigates to the phone verification 1808. When the clicks on forgot password, the email login 1804 navigates to the forgot password 1810. The phone verification 1808 takes inputs from the OTP received on the user's electronic device such as mobile phone. After the user enters the OTP and clicks on NEXT button, the phone verification 1808 page navigates to the profile/bio 1812. The generated prototype of the application having the screen flow view is shown in FIG. 18A.

Referring to FIG. 18B, FIG. 18B is an illustration of a subset 1850 of screen flow view of FIG. 18A. The screen flow view as shown in FIG. 18B illustrates a linkage between “Phone Verification” feature 1808 and other features such as Email Login 1804 and a Profile/Bio 1812.

The linkage between the different features is shown by arrows connecting the different features. By selecting the Features “Phone Verification” 1808 from FIG. 18A, the linkage for the Phone Verification feature 1808 with other features is highlighted and shown as in FIG. 18B.

The linkage between the “Phone verification” feature 1808 and other features such as Email Login 1804 and the profile/bio 1812 is generated by one of the Link prediction module 1315 and the postprocess module 1325.

Referring to FIG. 19A, FIG. 19A is an illustration of a prototype represented as a graph 1900 for an exemplary application. The graph shows the output of the prototype generation system 1300. The customer has selected 45 features for building an application. One or more inputs from the customer as a buildcard having 45 features and historical data from the database coupled to the BKG are provided to the prototype generation system 1300.

Initially, the inputs are provided to the link prediction module 1315 of the prototype generation system 1300 to predict a linkage between each pair of the 45 features. The link prediction module 1315 initially selects a machine learning model that is required to predict the linkage between each pair of the 45 features. Upon selecting the machine learning model, the link prediction module 1315 predicts one or more linkages between the one or more features.

Once the linkage between each pair of the 45 features is identified, the inputs are processed to the launch screen selector 1320 to identify a launch screen feature or a start screen feature among the 45 features. Alternatively, the inputs are processed simultaneously by the launch screen selector 1320 along with the link prediction module 1315. The launch screen selector based on the inputs provided selects and/or recommends the start screen feature for the application.

The output from the link prediction module 1315 includes the linkage between the one or more features and a prototype of the application is generated having the graph view as shown in FIG. 19A.

Referring to FIG. 19B, FIG. 19B is an illustration of a prototype represented as a graph 1950 for an exemplary application. As shown in FIG. 19A, some of the features (i.e., barcode scanner 1910) may not be fully connected using the link prediction module 1315 of FIG. 13.

In order to get the fully connected flow, the output from the link prediction module 1315 is provided to the postprocess module 1325 to identify any missing linkages and to get fully connected flow. In the first step, the postprocess module 1325 classifies a list of features selected for the application development, as unconnected features and connected features.

Later, the post process module 1325 identifies one or more potential hotspots in the unconnected features and predicts the linkage for the unconnected features with the connected features based on the one or more identified potential hotspots to get fully connected graph as shown in FIG. 19B.

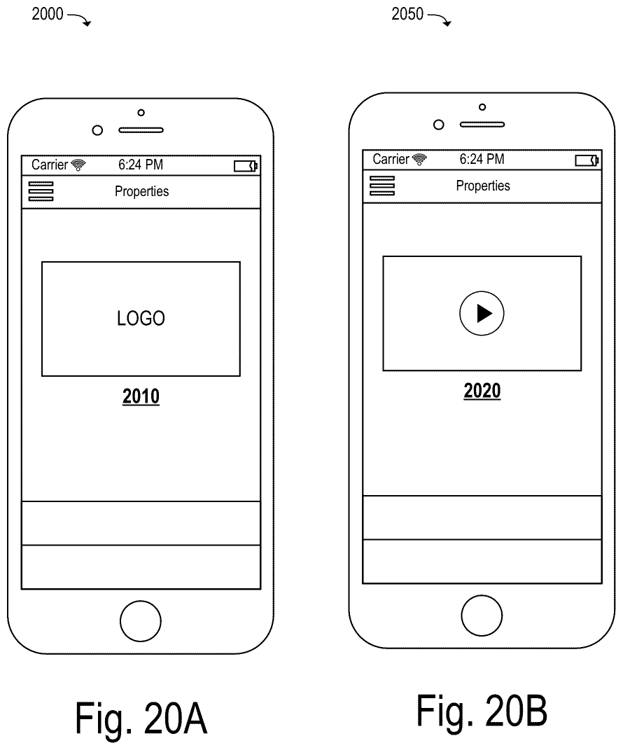

Referring to FIGS. 20A-20B, FIGS. 20A-20B are illustrations of launch screens 2000 and 2050 for two different exemplary applications. In an example scenario, assume that the customer has selected 45 features for building an application. One or more inputs from the customer as a buildcard having 45 features and historical data from the database coupled to the BKG are provided to the prototype generation system 1300. Initially, the inputs are provided to the link prediction module 1315 of the prototype generation system 1300 to predict a linkage between each pair of the 45 features. The link prediction module 1315 initially selects a machine learning model that is required to predict the linkage between each pair of the 45 features. Upon selecting the machine learning model, the link prediction module 1315 predicts one or more linkages between the one or more features.

Once the linkage between each pair of the 45 features is identified, the inputs are processed to the launch screen selector 1320 to identify a launch screen feature or a start screen feature among the 45 features. Alternatively, the inputs are processed simultaneously by the launch screen selector 1320 along with the link prediction module 1315.

The launch screen selector based on the inputs provided selects and/or recommends the start screen feature for the application. In order to recommend and/or select the one or more launch screens or the start screen feature for the application, the launch screen selector 1320 is configured to receive a hierarchical relationship between the one or more features from the link prediction module 1315. The launch screen selector 1320 is then configured to identify a type of application based on the application template. Upon identifying the type of application, the launch screen selector 1320 is configured to input the type of application and the one or more features to a first machine learning model and recommend the launch screen for the application based on an output of the first machine learning model. By implementing the above process, the launch screen selector 1320 selects/recommends the start screen feature having a feature displaying logo of the company/individual 2010 for an exemplary application as shown in FIG. 20A.

Similarly, for another exemplary application, the launch screen selector 1320 is configured to select/recommend the start screen feature having a feature displaying videos of the company/individual 2020 as shown in FIG. 20B.

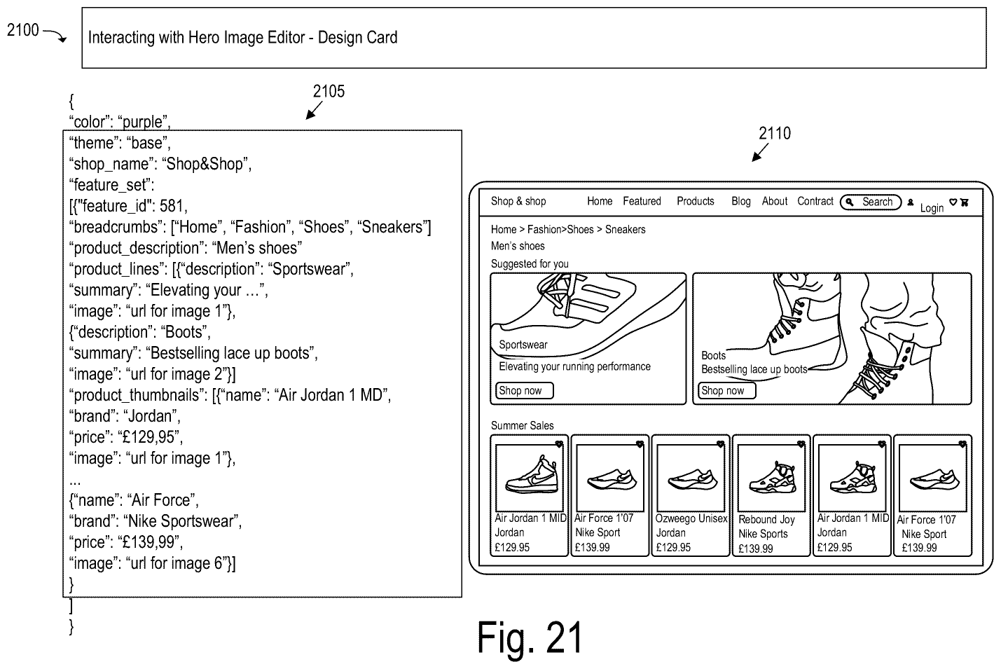

Accruing to FIG. 21, FIG. 21 is a screenshot 2100 showing data variables 2105 and a hero image 2110 that is modified by data variables. The data variables may take a variety of formats. In the screenshot 2100, the data variables are presented in JSON format. The data variables may each represent elements of the hero image 2110. Modifying the data variable may allow automated system to edit the various elements of the hero image.

In various embodiments, the entity tagger 1118 may determine one or more elements of the data variables 2105 to be modified based on a communication with the user. Likewise, the feature tagging model 1126 of the dialogue manager 1112 may edit the selected data variables based on the communication with the user.

For example, a user may specify that the text at the top of the page displaying, “Home>Fashion>Shoes>Sneakers” is too wordy and therefore confusing. The entity tagger 1118 may identify “feature_id”: 581 so that it may be edited. In another example, the user may specify the images of shoes at the bottom of the screen are inappropriate because they are not dress shoes. The entity tagger may identify the “product_thumbnails” tag that represents the images for the shoes so the inmate be edited.

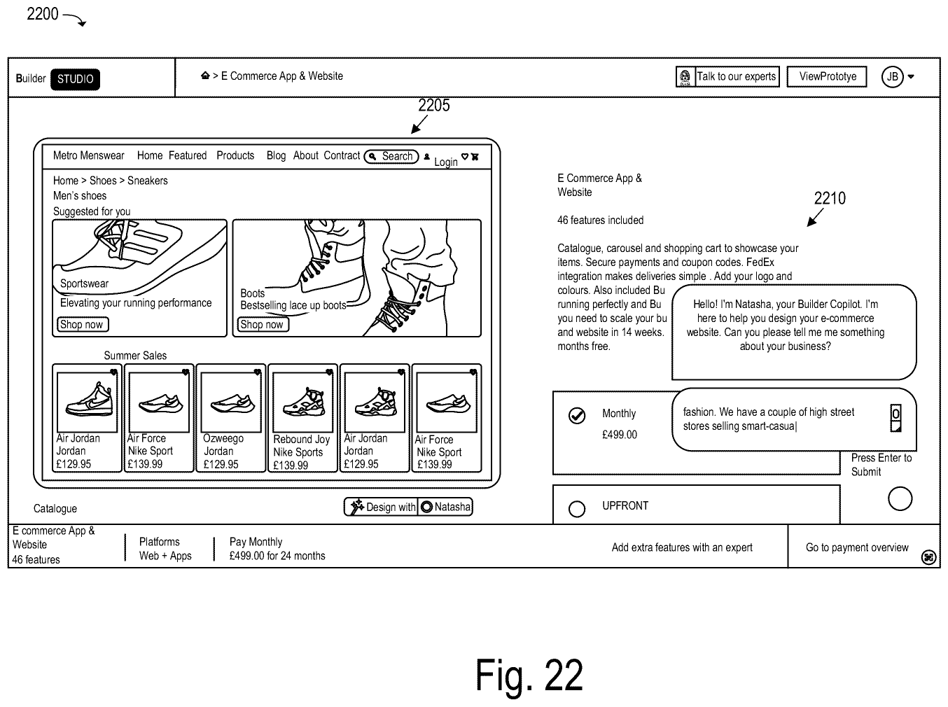

Referring to FIGS. 22-29, FIGS. 22-29 are a series of screenshots depicting a generative AI system that generates web page content in real time based on an interaction of a chat system with a user. The series of screenshots show how a software application may be added or modified based on a communication with the user. The series of screenshots further show how content may be generated by the automated system responsive to a communication with the user.

Referring to FIG. 22, FIG. 22 is a screenshot 2200 of a webpage display that is being presented to a user while the user is engaged in a chat with an automated system. The screenshot 2200 shows a display 2205 of a webpage and a chat session 2210 between a user and automated system. The communication between the user and the automated system is being made for the purpose of designing a webpage to sell clothing goods. The automated system displays a prompt that requests the user to describe the user's business. The user responds that the user is selling fashion products and that they have stores selling “smart-casual” products.

The display 2205 shows a template for selling fashion goods. The automated system may select a feature template (such as a list of features) or a software application template such as a website and then modify features or elements of the template based on the communication with the user. In various embodiments the automated system selects the template based on communication with the user. An exemplary embodiment the user selects a template and communicates with the automated system to edit the template.

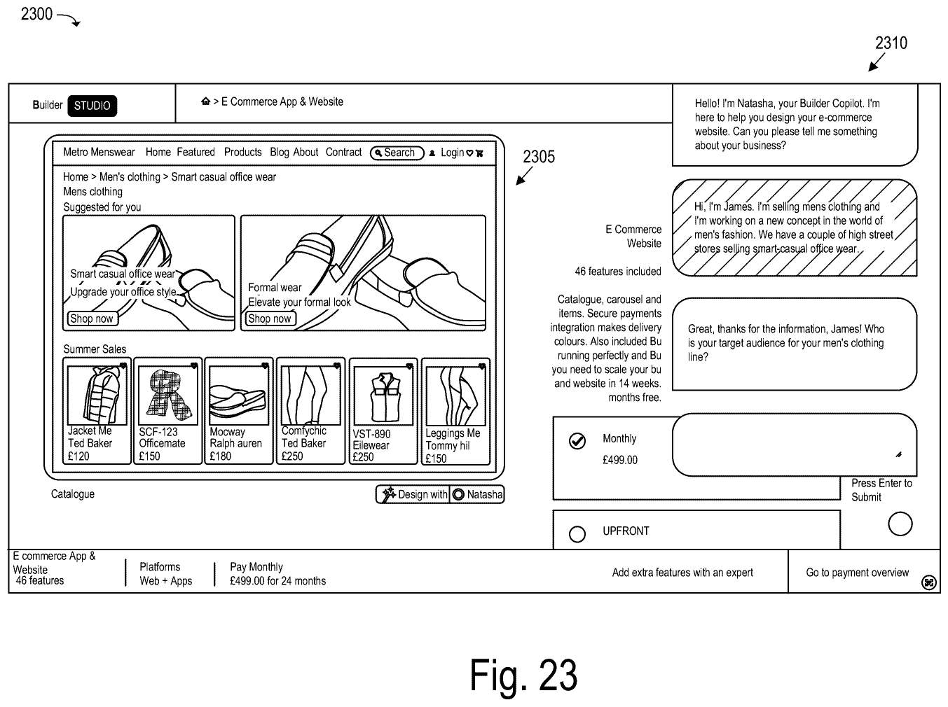

Referring to FIG. 23, FIG. 23 is a screenshot 2300 of a webpage display that is a continuation of the chat shown in the screenshot 2200 of FIG. 22 while the user is engaged in a chat with an automated system. The automated system edited the images and text shown in the display 2305 of a webpage. Accordingly, the display 2305 shows dress shoes, dress scarves, dress pants, and vests. The text in the upper images is also modified to reflect high-fashion as the target product. The chat session 2310 shows that the automated system is prompting the user to identify a target audience for the closing products.

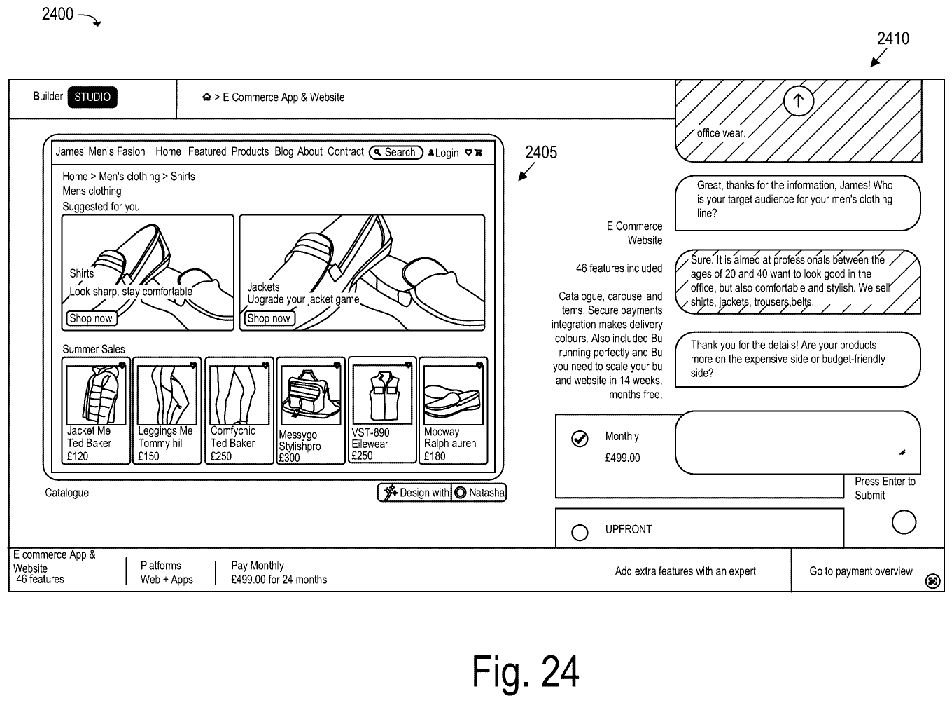

Referring to FIG. 24, FIG. 24 is a screenshot 2400 of a webpage display that is a continuation of the chat shown in the screenshot 2300 of FIG. 23 while the user is engaged in a chat with an automated system. The user responds in the chat session 2410 that the target audience are professionals between the ages of 20 and 40 who want to look good in the office but also comfortable and stylish. User also adds that they sell shirts, jackets, trousers, and belts.

The automated system responds both with text and by updating the image shown in the display 2405. The text in the upper two images is updated to reflect the target audience and products sold by the user. The images on the bottom are also updated to reflect products that were listed by the user. The automated system responds in a text to prompt the user to answer a question as to whether the products are expensive or budget friendly.

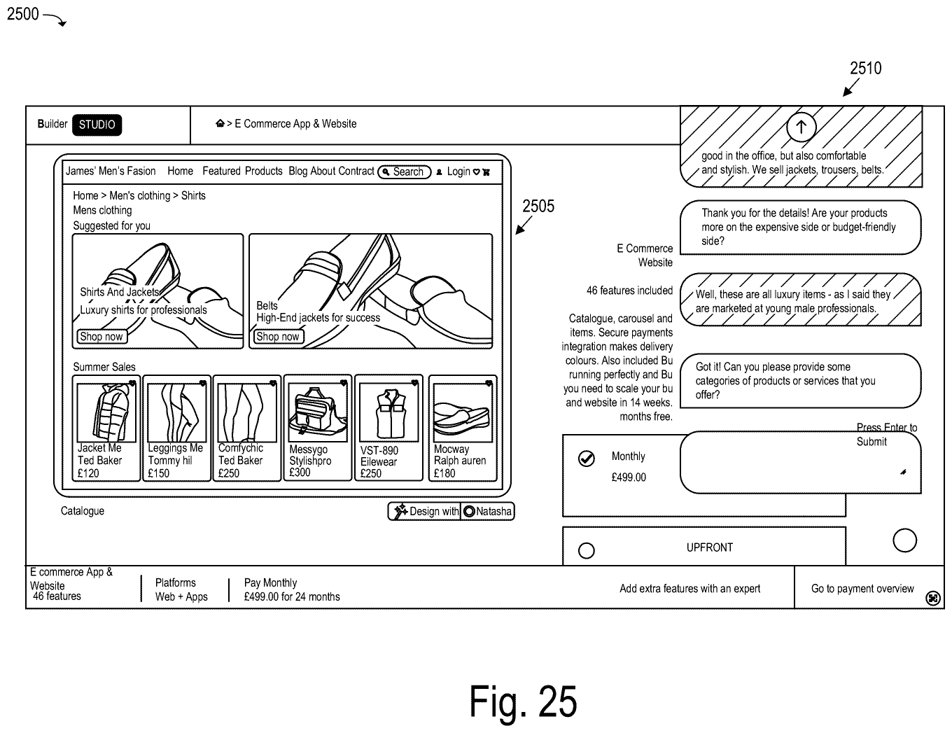

Referring to FIG. 25, FIG. 25 is a screenshot 2500 of a webpage display that is a continuation of the chat shown in the screenshot 2400 of FIG. 24 while the user is engaged in a chat with an automated system. The text in the upper two images is further updated in the screenshot 2500 to reflect the user's answer to the question in chat session 2410 as to the cost of the products. The user responds in the chat session 2510 that the products are luxury items and are marketed to young male professionals. The automated system responds both by updating the display 2505 of the webpage and with a text response to the user. The text in the upper two images of the display 2505 is edited based on the user's answer. The automated system responds to the user's chat session 2510 by prompting the user to provide categories of products or services that the user offers.

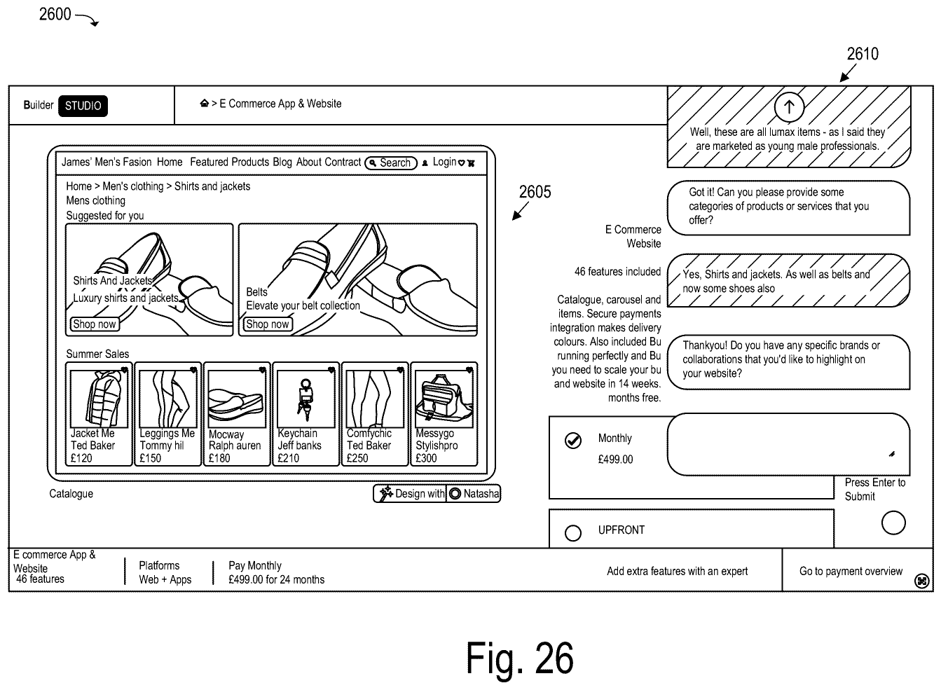

Referring to FIG. 26, FIG. 26 is a screenshot 2600 of a webpage display that is a continuation of the chat shown in the screenshot 2500 of FIG. 25 while the user is engaged in a chat with an automated system. The user responds to the question from the chat session 2510 by answering that the categories include shirts and jackets as well as belts and shoes. The automated system responds by updating the display 2605 and prompting the user with a further question. The display 2605 is updated by displaying products that reflect the user's answer on the bottom of the display 2605. The automated system further responds to the user in the chat session 2610 by prompting the user to highlight any specific brands or collaborations. This prompt allows the automated system to refine features of the website design based on the user's responses.

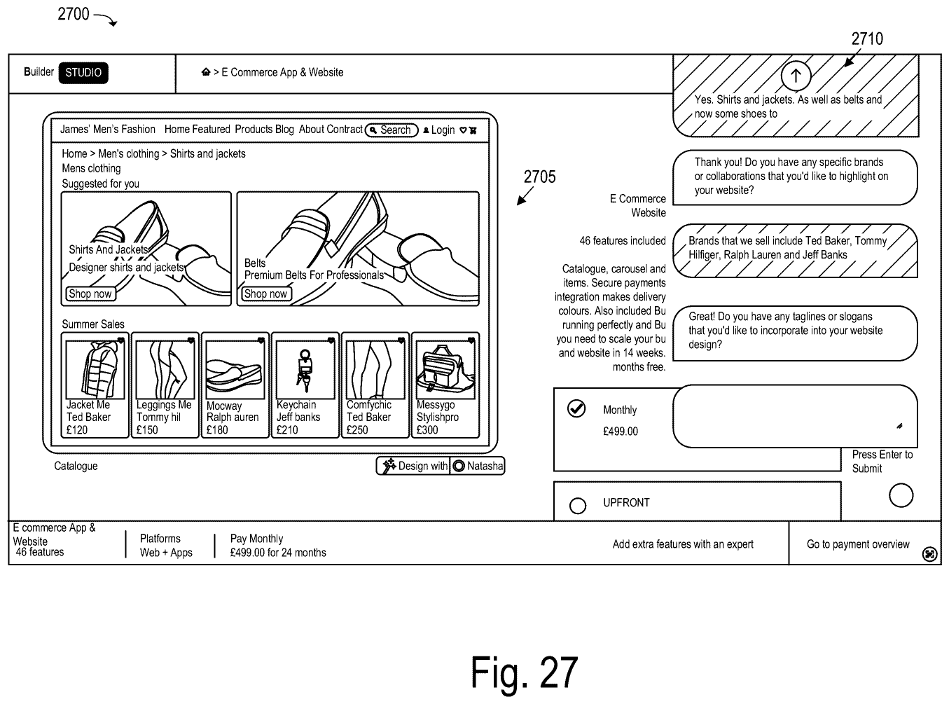

Referring to FIG. 27, FIG. 27 is a screenshot 2700 of a webpage display that is a continuation of the chat shown in the screenshot 2600 of FIG. 26 while the user is engaged in a chat with an automated system. The automated system responds to the user's answer from the previous chat session 2610 by editing the text for the upper two images in the display 2705. The automated system further prompts the user in a chat session 2710 to disclose any taglines or slogans that the user like to incorporate in the website design. The prompt allows the automated system to further refine the website design based on the user's next response.

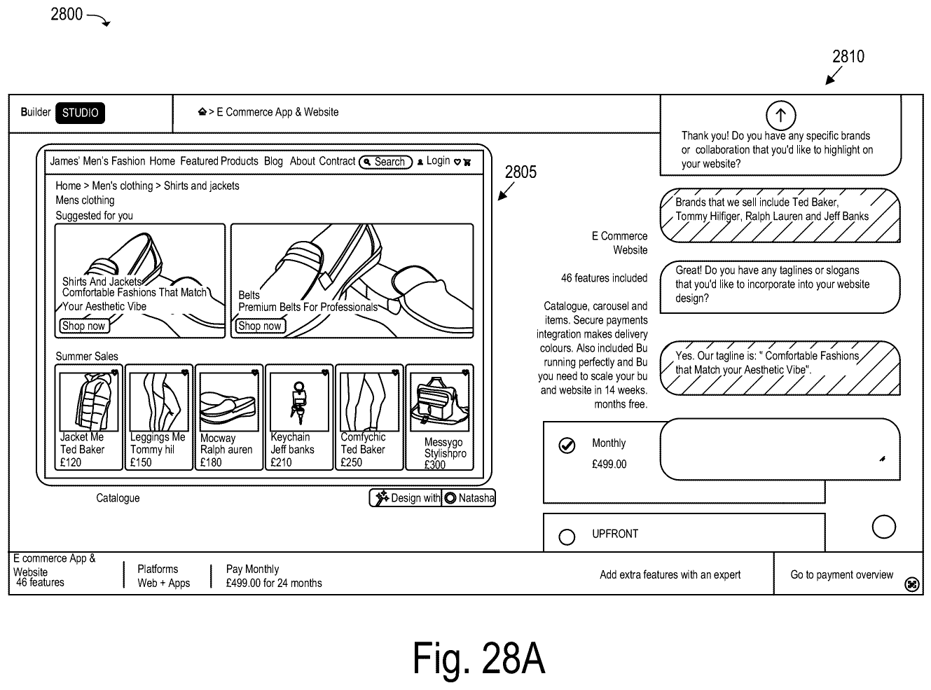

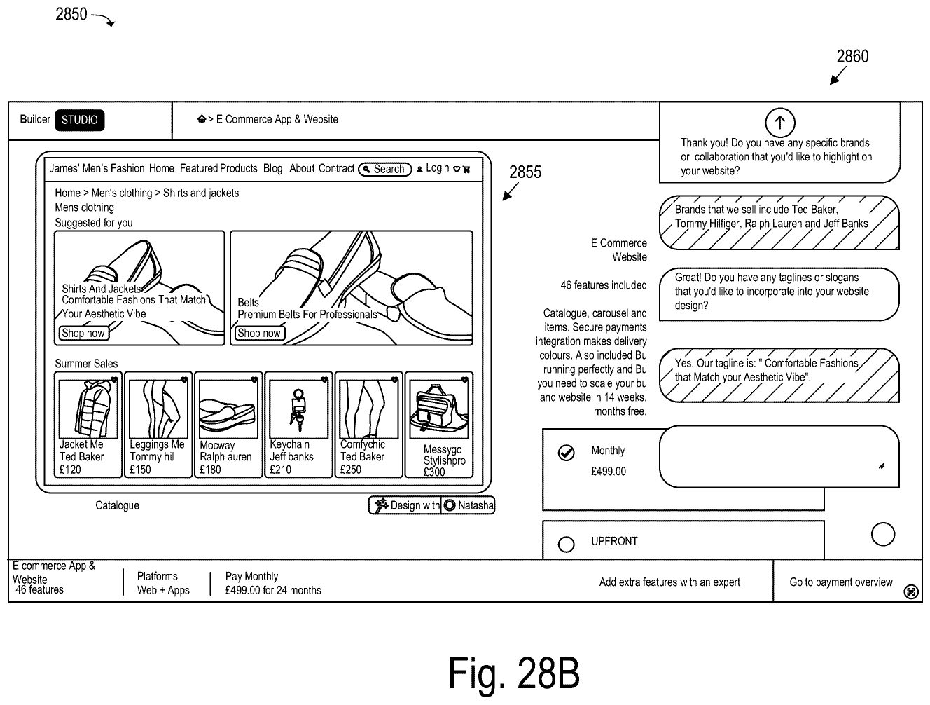

Referring to FIGS. 28A and 28B, FIG. 28A is a screenshot 2800 of a webpage display that is a continuation of the chat shown in the screenshot 2700 of FIG. 27 while the user is engaged in a chat with an automated system. The automated system refines the display 2805 by updating text for the upper left image.

FIG. 28B is a screenshot 2850 of the webpage display 2855 and a chat session 2860. The automated system for the responds to the user's answer in the previous chat session 2810 by prompting the user in a chat session 2860 to reveal any taglines or slogans that they would like to incorporate in the website design. The automated system responds to the user's answer by updating text in the upper left image of the display 2855.

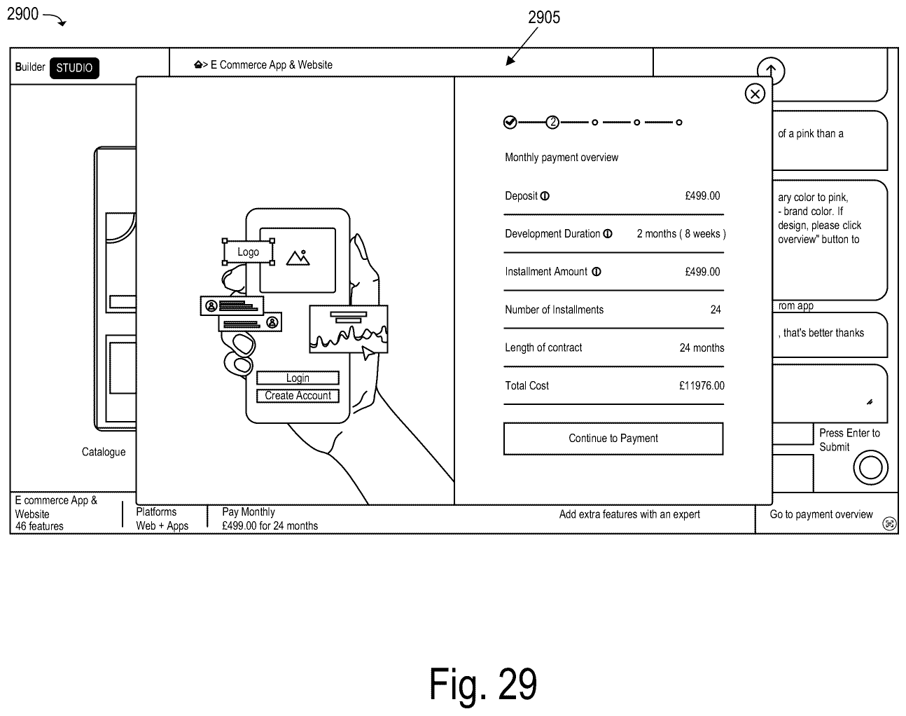

Referring to FIG. 29, FIG. 29 is a screenshot 2900 of a webpage display 2905 that is a continuation of the chat shown in the screenshot 2850 of FIG. 28B while the user is engaged in a chat with an automated system. The webpage display 2905 shows a cost for developing a webpage based on the features and design that were described by the user in FIGS. 22-28B. In various embodiments, the cost may be determined based on training data for previous software applications with similar features.

In various embodiments, a user may describe custom features whereby the cost of the custom feature could be determined based on similarity of the custom feature to features that were previously developed. In various embodiments, the cost may be determined based on a template for the software application that is presented to the user. Modifications to the template may result in modifications to the cost.

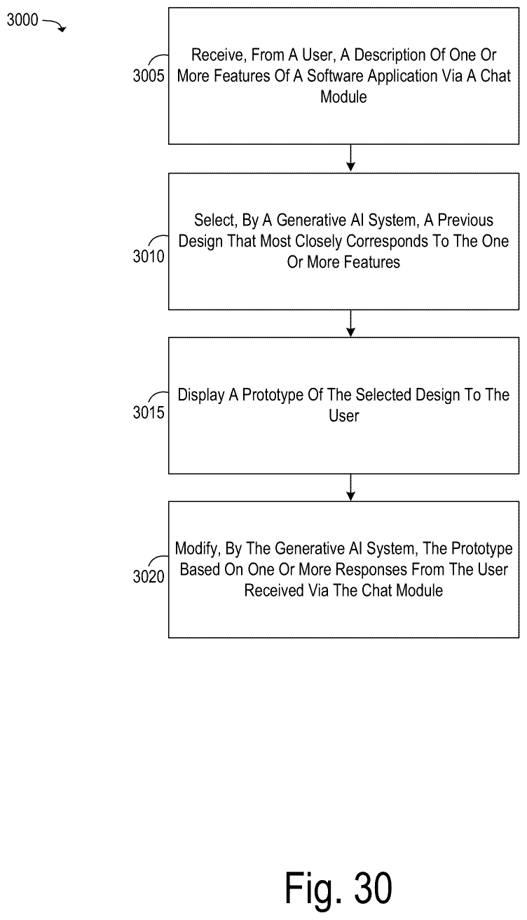

Referring to FIG. 30, FIG. 30 is a flow diagram 3000 for a process for determining a software application design for an idea. For instance, a user may have an idea for a software application design. The process may be used to display and modify a prototype of the software application design based on an interaction with a user. In an exemplary embodiment, an automated system interacts with the user to determine the software application design.

At step 3005, the process may receive, from a user, a description of one or more features of a software application design via a chat module. These features can be recognized by using natural language processing (NLP). For instance, based on a chat conversation with a user, the automated system may be able determine a software application feature such as a login feature, a sign up feature, a payment processing feature, and so on.

At step 3010, the process may select, by a generative AI system, a previous design that most closely corresponds to the one or more features. For example, the generative AI system may analyze previous software application designs stored in a database and select the design that contains the most features that are the same/similar to the described features.

At step 3015, the process may display a prototype of the selected design to the user. For example, the process may display the previous design to the user on their device. Alternatively, the automated system may edit the selected design before displaying the prototype. For instance, a user may describe several features in step 3005. While the selected design may include many of these features, it may be missing others. The automated system could then modify the selected design to include such missing features by using historical data from other preexisting designs.

As mentioned previously with respect to FIGS. 17A-17B, with prototype may be displayed as a screen flow view, with arrows representing linkages between the one or more features. Alternatively, as previously mentioned with respect to FIGS. 19A-19B, the prototype may be displayed as a graph view, with nodes representing the one or more features.

At step 3020, the process may modify, by the generative AI system, the prototype based on one or more responses from the user received via the chat module. For instance, the user may wish to change the appearance of the landing page. As another example, the user may wish to add a phone verification feature. The generative AI system can use data from previous software application designs to make such modifications. The prototype (which can be, for example, a screen flow view or graph view) can be modified and displayed in real time, and the process can be repeated until a final design is determined.

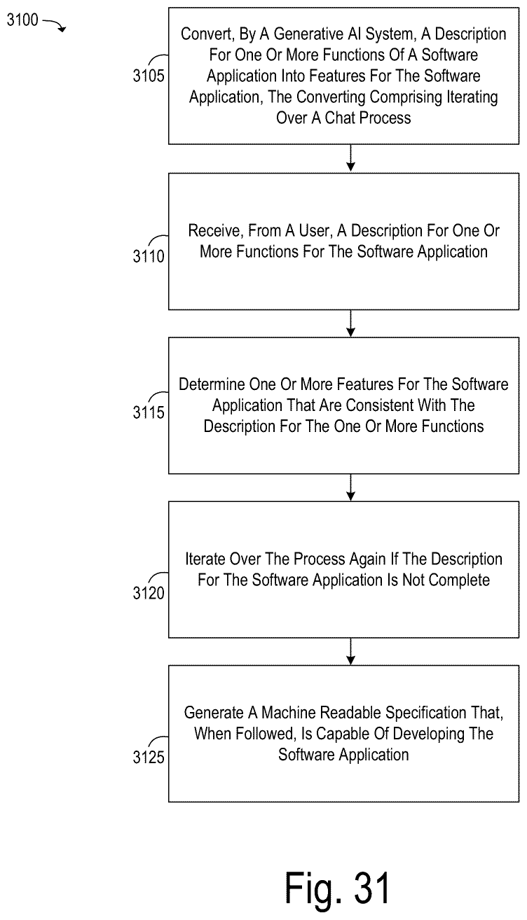

Referring to FIG. 31, FIG. 31 is a flow diagram 3100 for a process for converting an idea into a machine readable specification. The process may be used to convert a user's description of a software application into a machine readable specification that, when followed, may result in a developed software application. In an exemplary embodiment, an automated system may interact with the user via a communication to convert the user's idea into a machine readable specification.

At step 3105, the process may convert, by generative AI system, a description for one or more functions of a software application into features for the software application where the converting includes iterating over a chat process. The description for one or more functions may be conveyed by a user describing what they would like a software application to do. For example, a user may describe that the user wants a software application that connects people by proximity so that they may conduct mutual business with each other. The generative AI system may convert the user's description into features that may be developed into the described software application. An example of the feature that connects people by proximity may be a feature that collects a client user's location and compares it to another client user's location. An example of the feature that allows people to conduct mutual business with each other may be a feature that determines whether the client users are likely to be able to conduct mutual business.

At step 3110, the process may receive, from a user, a description for one or more functions for the software application. In an exemplary embodiment, the user may describe the one or more functions for the software application using ordinary language. The generative AI system may use natural language processing (NLP) to parse the ordinary language and convert it into a form that can be read and understood by an automated system.

At step 3115, the process may determine one or more features for the software application that are consistent with the description for the one or more functions. The generative AI system may attempt to match pre-developed features for software applications to the descriptions of the one or more functions. For example, when a user describes a function to allow a client user to login to application, the generative AI system may determine a set of features that can authenticate a client user via a login and password.

At step 3120, the process may iterate over the process again if the description for the software application is not complete. The generative AI system may be configured to determine whether the user's description is complete. In various embodiments, the generative AI system may use training data for previous communications to determine when a user's description is complete. In an example, the generative AI may prompt the user to describe a software application in a broad sense and then prompt the user to describe it in narrower and narrower details until the descriptions become sufficiently narrow.

In an exemplary embodiment, the generative AI system may have a narrowness threshold that determines that one or more features have been sufficiently described if they pass a level of narrowness. Narrowness they may be defined in multiple ways. In an example narrowness for a function may be defined by a number of descriptions for the function. For example, a user may request that a software application displays a start screen. The user may be prompted to provide descriptions for the start screen that include that (1) the start screen has a start button, (2) that the start screen includes an animated logo, and (3) at the start screen includes a text that describes the functionality of the software application. Accordingly, the user may have provided 3 descriptions for the start screen function. In an exemplary embodiment where the threshold for narrowness is set to 3 descriptions, the generative AI may determine that the start screen was sufficiently described.

At step 3125, the process may generate a machine readable specification that, when followed, is capable of developing the software application. The machine readable specification may be in a format that may be followed by an automated system, a human designer, a human developer, or combinations thereof. In various embodiments, the machine readable specification is followed entirely by an automated system to generate a software application.

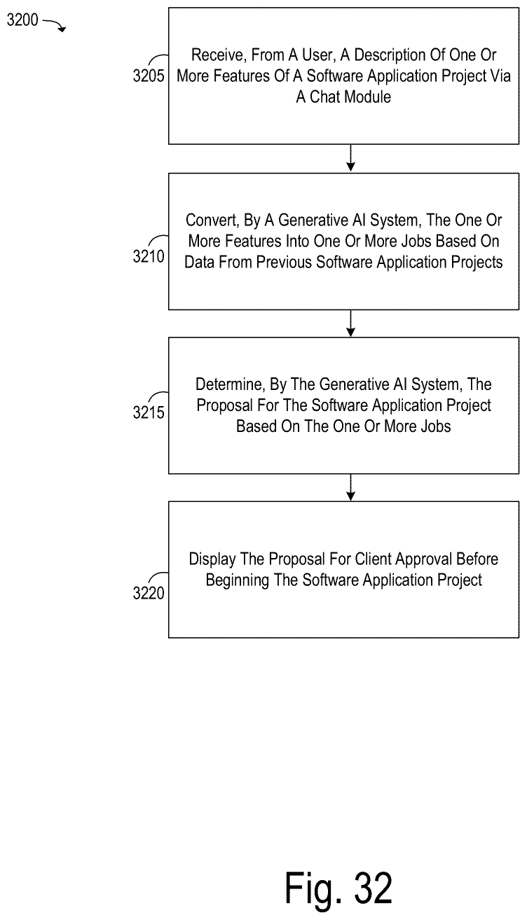

Referring to FIG. 32, FIG. 32 is a flow diagram 3200 for a process for determining a proposal for a software application project. In an exemplary embodiment, an automated system conducts a chat conversation with a user about desired features of a software application. The automated system can then determine a cost and/or a timeline of the project based on previous projects.

At step 3205, the process may receive, from a user, a description of one or more features of a software application via a chat module. These features can be received using natural language processing (NLP). For instance, in a chat conversation, a user may describe the desired functionality and/or appearance of the software application. As one example, a user may want a software application for selling three separate products, each having its own unique page with different colors and imagery.

At step 3210, the process may convert, by a generative AI system, the one or more features into one or more jobs based on data from previous projects. For instance, the generative AI system may convert the three-product idea into jobs. From previous projects stored in a database, the generative AI system may determine that this idea requires a job for creating each page, a job for using a unique color on each page, a job for each image included on the page, etc.

At step 3215, the process may determine, by the generative AI system, the proposal for the software application project based on the one or more jobs. For example, based on the previous projects, the generative AI system may determine a cost and timeline for each job. Then, the generative AI system can add the cost and timeline for all required jobs, to arrive at a total cost and timeline for the project.

At step 3220, the process may display the proposal for client approval before beginning the software application project. For instance, the automated system can display a cost and timeline for the project on the user's device. Should the user choose to modify or add a feature, e.g., the client user wants to add an additional product, or wishes to add more images and colors on each page, the automated system can modify the cost and timeline accordingly by repeating steps 3205, 3210, 3215, and 3220. In this way, the automated system is able to display a cost and timeline in real time as the user makes changes to the design. Further, the cost and timeline can be displayed together with a template or prototype of the software application, which is also being modified in real time.

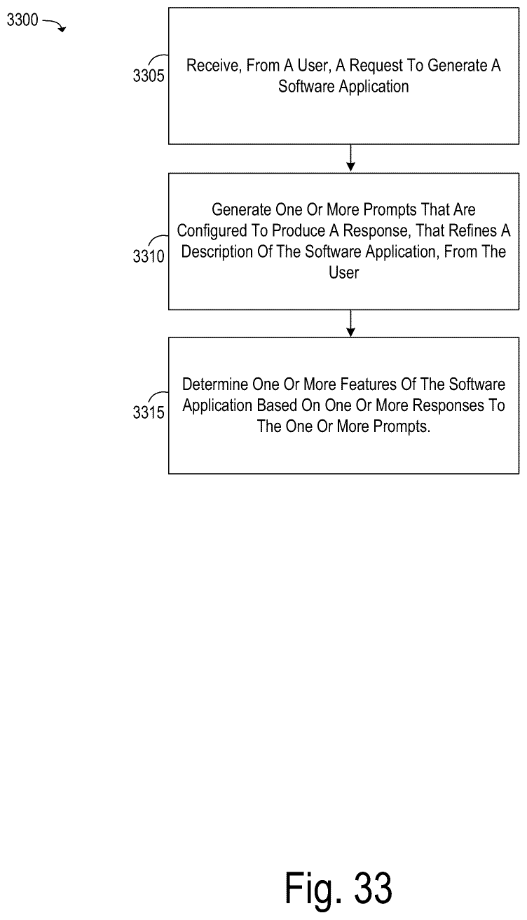

Referring to FIG. 33, FIG. 33 is a flow diagram 3300 for a process for determining questions to ask a user to discern desired features for a project. An automated system may determine the questions in order to prompt a user to sufficiently describe a software application. Once the software application is sufficiently described, a generative AI may generate a machine readable specification that may be followed to develop the software application.

At step 3305, the process may receive, from a user, the request to generate a software application. In various embodiments, the request to generate the software application may take the form of selecting a template for a software application. An automated system may then refine the template based on a communication with the user. In an exemplary embodiment, the software application will not have a defined template prior to receiving a description of the software application from the user. For example, the user may simply select a button on a webpage to begin development of a software application, whereby an automated system begins a communication with the user and prompts the user to describe the software application.

At step 3310, the process may generate one or more prompts that are configured to produce a response that refines a description of the software application from the user. The term refines, as used herein, may refer to the process of adding details to a description for a function or feature of a software application. In various embodiments, the automated system may prompt a user to provide a minimum number of details for each function that the user describes. The minimum number of details may be dependent on the type of function. For example, the automated system may be trained to prompt a user to supply X number of details for a type of function. A type of function may be a classification of a function. An example of a classification of function may be a login function, communication function, user interface function, input function, display function, and the like.

At step 3315, the process may determine one or more features of the software application based on one or more responses to the one or more prompts. In an exemplary embodiment, the automated system may engage in a back-and-forth communication with the user where the automated system repeatedly prompts the user to refine a description of functions for the software application. The automated system may then convert the user's description of functions for the software application into one or more features of the software application. In an exemplary embodiment the automated system may perform the conversion using training data that converts descriptions of functions into features for software applications.

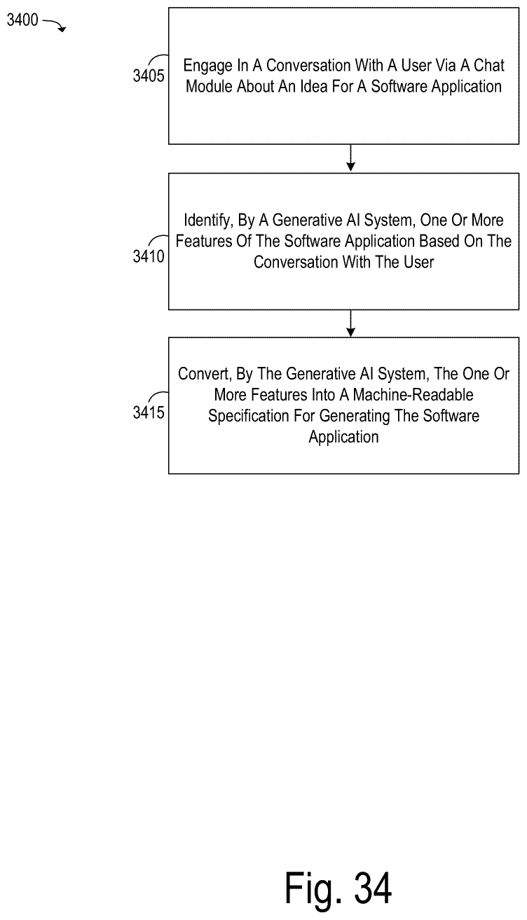

Referring to FIG. 34, FIG. 34 is a flow diagram 3400 for a process for generating a software application for an idea. Generative AI may use natural language processing (NLP) to generate features for a software application based on a conversation with a user. For instance, an AI bot may identify a set of one or more specific features for a software application that can be converted into a machine-readable specification.

At step 3405, the process may engage in a conversation with a user about an idea for a software application via a chat module. For example, the user may communicate an idea for a software application for a particular type of business, such as selling a product or service. In addition, the user may communicate an idea about how the software application should appear and function.

At step 3410, the process may identify, by a generative AI system, one or more features of the software application based on the conversation with the user. The generative AI system can use natural language processing (NLP) to extract relevant information. For example, the generative AI generative system may determine various features of the software application based on the chat conversation with the user. For example, the generative AI system may determine the appearance of the software application, including color, imagery, and text components. In addition, the generative AI generative system may determine how the software application is intended to function or behave. In an exemplary embodiment, the AI generative system may determine that the application should allow a customer to browse through images of the product, select a product to purchase, and purchase the selected product. The automated system can identify such features by referring to previous software applications.

At step 3415, the process may convert, by the generative AI system, the one or more features into a machine-readable specification for generating the software application. When followed, the machine-readable specification is capable of developing the software application. The machine-readable specification may be in a format that may be followed by an automated system, a human designer, a human developer, or combinations thereof. In various embodiments, the machine-readable specification is followed entirely by an automated system to generate a software application.

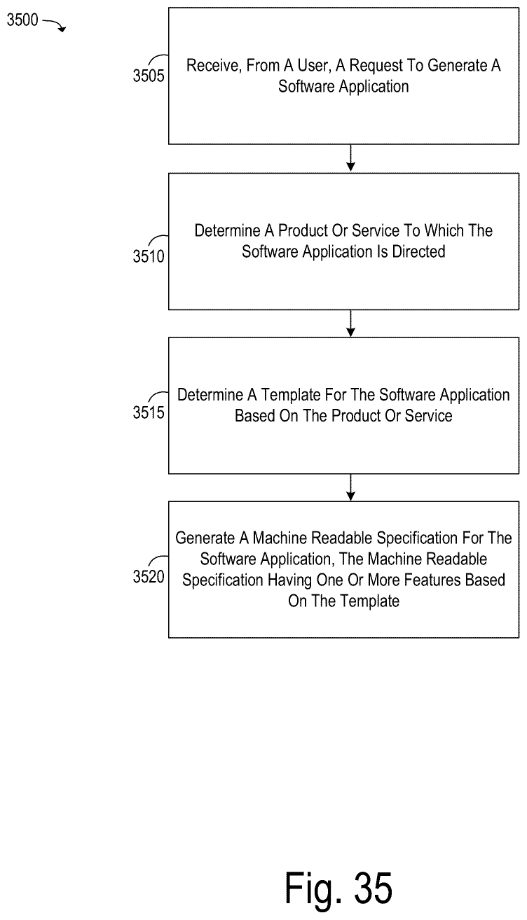

Referring to FIG. 35, FIG. 35 is a flow diagram 3500 for a process for determining products or services based on a conversation. The process may be implemented by an automated system to determine what types of products and services a user wishes to target for a software application. For example, a user may wish to develop a software application that sells products or services. The overall structure or template for the software application may be necessarily different based on the products or services. Accordingly, the automated system will save time and expense by determining what type of product or service the user wishes to target. Thus, the automated system may converse in a back-and-forth communication with the user to determine what type of product or service to which the user wishes to direct the software application.

At step 3505, the process may receive, from a user, a request to generate a software application. In various embodiments, the request may be selecting a button or making a chat request or submitting a similar instruction to an automated system to develop a software application. The user may or may not include a product or service description in the request. Even if the user does include a product or service description, the description may not be complete or may be incorrect.

At step 3510, the process may determine a product or service to which the software application is directed. In an exemplary embodiment, the automated system may prompt the user to describe the product or service that they are selling. In various embodiments the automated system may prompt the user to describe the functionality of the software application whereby the automated system may infer the product or service from the description of the functionality. For example, a user may describe the product or service as clothing. But upon prompting, the user may describe a function to personally deliver clothing to the address of a client user in a function to personally pick up the clothing once the client user is done wearing it. Accordingly, the automated system may infer that the user is describing an Uber style rental service for clothing.

At step 3515, the process may determine a template for the software application based on the product or service. The term template may refer to an overall structure for a software application in various embodiments, the template may include pre-developed features for the software application. The automated system may prompt the user to describe additional functions for the software application to make changes to one or more features for the template.

At step 3520, the process may generate a machine readable specification for the software application where the machine readable specification has one or more features based on the template. The machine readable specification may be configured to allow an automated system, a designer, a developer, or combination thereof to develop a software application. In various embodiments, the determined template includes a preconfigured machine readable specification whereby the generated machine readable specification will only differ from the preconfigured machine readable specification in the modifications or edits made by the user to the template.

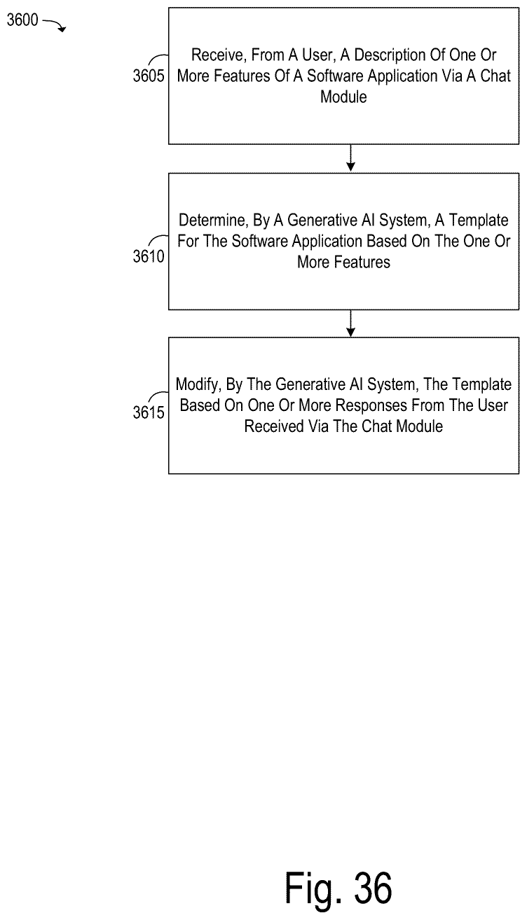

Referring to FIG. 36, FIG. 36 is a flow diagram 3600 for a process for determining a template for a software application based on a conversation. In an exemplary embodiment, an automated system conducts a chat conversation with a user about desired features of a software application. The automated system can then determine a template of the software application. This template can be modified based on further information provided by the user during the chat conversation.

At step 3605, the process may receive, from a user, a description of one or more features of a software application via a chat module. These features can be received using natural language processing (NLP). For instance, based on a chat conversation with a user, the automated system may determine a type of service or business for which the user intends to use the software application. As another example, based on the chat conversation, the automated system may determine a style or format desired by the user.

At step 3610, the process may determine, by a generative AI system, a template for the software application based on the one or more features. This template may be a preexisting template from a prior software application. For example, the generative AI system may analyze previous templates stored in a database and select a template directed to the same or similar type of business. The generative AI system may also select a template with a similar style or format. Alternatively, the template may be a custom template. For example, the automated system may combine aspects of one or more preexisting templates to create a custom template.

At step 3615, the process may modify, by the generative AI system, the template based on one or more responses from the user received via the chat module. In an exemplary embodiment, the automated system may display the determined template to the user on the user's device. This could be, for example, a template of a website. The user may indicate in the chat conversation that they wish to make certain changes to the template. For instance, the user may wish to change the template to include different colors, imagery, or textual components. The automated system then modifies the template to include these changes; it can use historical data from other software applications and/or software application templates in order to make these changes. The user can continue to request further changes in response to prompts from the chat module. Thus, the template may be repeatedly modified using an iterative process and displayed to the user in real time. Once the user is satisfied with the template, and requests no further changes, the template can be used to generate a machine readable specification for developing the software application.

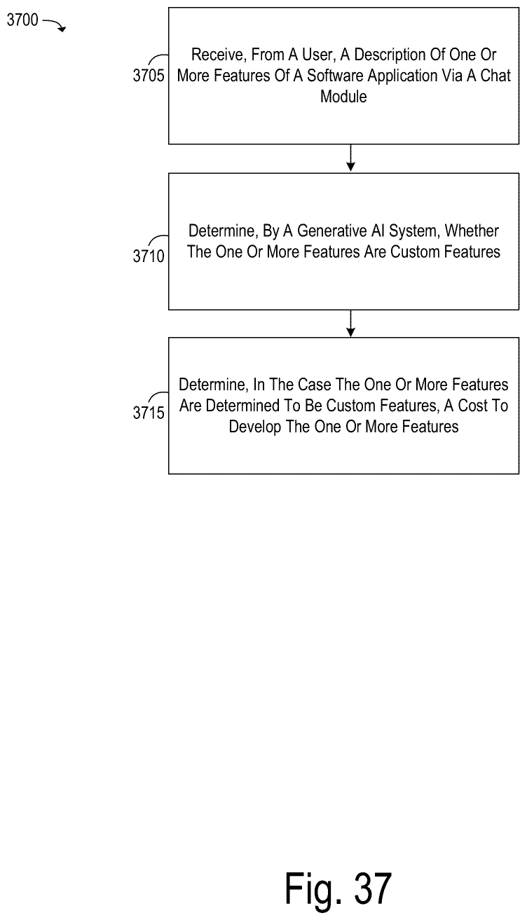

Referring to FIG. 37, FIG. 37 is a flow diagram 3700 for a process for determining a cost for developing features of a software application based on a conversation. This may be directed to new software application features that have yet to be developed.

At step 3705, the process may receive, from a user, a description of one or more features of a software application via a chat module. These features can be received using natural language processing (NLP). For instance, the system may determine that the user would like to include a particular button or menu option in the software application.

At step 3710, the process may determine, by a generative AI system, whether the one or more features are custom features. For example, the automated system may search a database of preexisting software applications to determine if any of those applications utilize the particular button or menu option identified by the user. The automated system may be unable to locate this feature, and therefore determine that the requested feature is a new or custom feature. As such, the determination of whether the one or more features are custom features may be based on historical data and input from the user.

At step 3715, the process may determine, in the case the one or more features are determined to be custom features, a cost to develop the one or more features. The cost may be determined based on similarity of the one or more features to previously developed features. For instance, the automated system may locate one or more preexisting software applications with a button or menu option similar to the one identified by the user. The automated system may determine the cost to develop the new feature by analyzing the cost to develop the previous feature(s). For example, in the case that there are two similar previous features, the system might use their average cost to determine the cost of the new feature.

The determined cost may be displayed to the user before beginning development of the software application. In addition, a prototype of the custom feature may be generated and displayed to the user. The cost may be displayed at the same time as display of the prototype. Once the user agrees to the cost and decides to proceed, the system may generate a machine-readable specification for the software application. The machine-readable specification may include a marker that identifies a portion that can be customized to include the new feature.

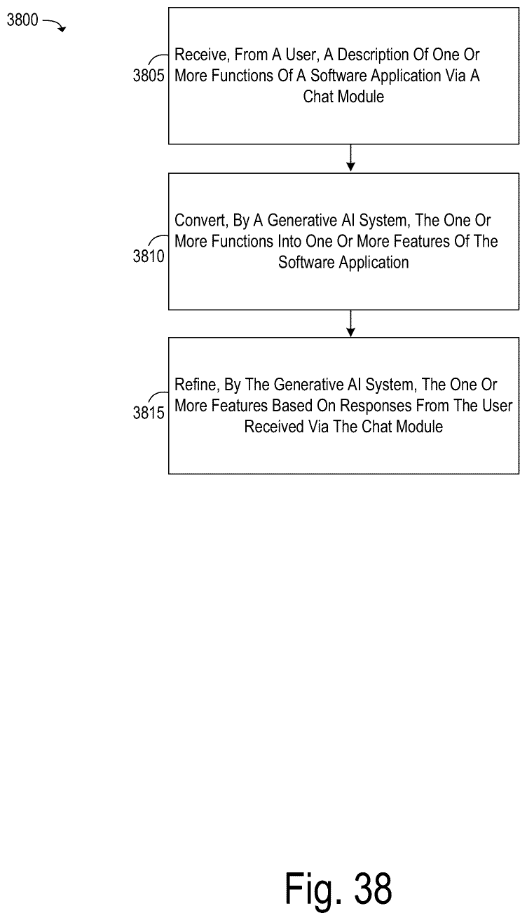

Referring to FIG. 38, FIG. 38 is a flow diagram 3800 for a process for refining a feature of a software application based on a conversation. The system may take a feature and make incremental changes based on direction from the user.

At step 3805, the process may receive, from a user, a description of one or more functions of a software application via a chat module. In an exemplary embodiment, the user may describe the one or more functions for the software application using ordinary language. The generative AI system may use natural language processing (NLP) to parse the ordinary language and convert it into a form that can be read and understood by an automated system.

At step 3810, the process may convert, by a generative AI system, the one or more functions into one or more features of the software application. The generative AI system may attempt to match pre-developed features for software applications to the descriptions of the one or more functions. For example, when a user describes a function to allow a client user to login to the application, the generative AI system may determine a set of features that can authenticate a client user via a username and password.

At step 3815, the process may refine, by the generative AI system, the one or more features based on responses from the user received via the chat module. For instance, the user may indicate that they would like the login process to include enhanced security. In response, the generative AI system may refine the username/password features to add certain password complexity rules (e.g., special symbols, minimum number of characters, etc.). In addition, the generative AI generative system may refine the username/password features to include two-factor or biometric authentication.

The process may include generating a template containing the one or more features and displaying the template to the user. The template may then be modified to include the refined features based on user input. For example, the system may display a template of the login page to the user. After viewing the template, the user may request a more user-friendly login page. In response, the generative AI system may modify the template to include clearer labels and instructions.

Step 3815 may be repeated using an iterative process until the user is satisfied with the refined one or more features.

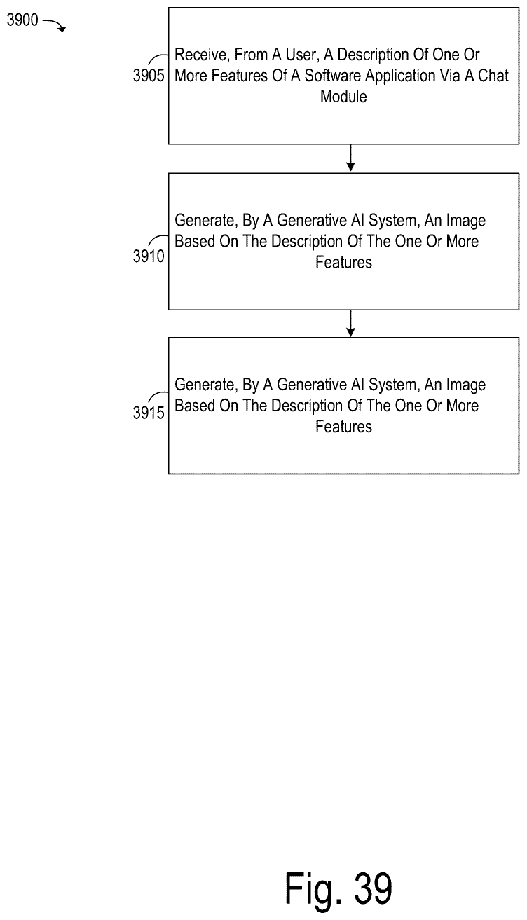

Referring to FIG. 39, FIG. 39 is a flow diagram 3900 for a process for generating an image for a software application based on a conversation. Like refining features, incremental changes may be made to the images based on the conversation.

At step 3905, the process may receive, from a user, a description of one or more features of a software application via a chat module. These features can be received using natural language processing (NLP). For instance, based on a chat conversation with a user, the automated system may determine that the user intends to use the software application for an e-commerce business selling energy drinks. The automated system further determines that the user desires a natural theme for the software application.

At step 3910, the process may generate, by a generative AI system, an image based on the description of the one or more features. For example, the system may generate a picture of an energy drink sitting on a rock with a forest background. The generative AI system may generate the image based on images used in prior applications. As an example, the forest background may have been used for a different type of product. The generative AI system may mix images from prior software applications. For instance, the automated system may mix a prior image of an energy drink with a prior image of a forest.

At step 3915, the process may display the generated image to the user. The generated image may be displayed by itself on the user's device or as part of a template of the application displayed on the user's device.

The generated image may be modified based on input from the user received in the chat conversation. For example, the user may request to change the forest background to include more tropical foliage. The user may wish to modify the size or type of the rock on which the product is displayed. The user may wish to change the view of the product (e.g., a different perspective view). The automated system can incrementally make these changes until the user is satisfied with the final image. The image may be modified within the template displayed to the user, such that the user can see the current version of the modified image relative to other imagery and textual components in the application.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions. For example, it is to be understood that the disclosure contemplates that, to the extent possible, one or more features of any embodiment can be combined with one or more features of any other embodiment.

1. A method for generating a software application, the method comprising:
receiving, from a user, a request to generate a software application;
determining a product or service to which the software application is directed;
determining a template for the software application based on the product or service;
generating a machine readable specification for the software application, the machine readable specification having one or more features based on the template.

2. The method of claim 1, further comprising determining one or more features for the software application based on the determined product or service.

3. The method of claim 2, further comprising generating one or more prompts that are configured to produce a response, from the user, that refines the determined product or service.

4. The method of claim 3, further comprising determining one or more features for the software application based on the refined determined product or service.

5. The method of claim 1, further comprising:
determining a price to develop the software application; and
transmitting the price to the user.

6. The method of claim 1, further comprising:
determining a timeline to develop the software application; and
transmitting the timeline to the user.

7. The method of claim 1, further comprising:
generating a prototype of a feature of the software application based on a response to a prompt; and
demonstrating the prototype to the user.

8. A computer system to generate a software application, the computer system comprising:
a processor coupled to a memory, the processor configured to execute a software to perform:
receive, from a user, a request to generate a software application;
determine a product or service to which the software application is directed;
determine a template for the software application based on the product or service;
generate a machine readable specification for the software application, the machine readable specification having one or more features based on the template.

9. The computer system of claim 8, wherein the processor is further configured to determine one or more features for the software application based on the determined product or service.

10. The computer system of claim 9, wherein the processor is further configured to generate one or more prompts that are configured to produce a response, from the user, that refines the determined product or service.

11. The computer system of claim 10, wherein the processor is further configured to determine one or more features for the software application based on the refined determined product or service.

12. The computer system of claim 8, wherein the processor is further configured to:
determine a price to develop the software application; and
transmit the price to the user.

13. The computer system of claim 8, wherein the processor is further configured to:
determining a timeline to develop the software application; and
transmitting the timeline to the user.

14. The computer system of claim 8, wherein the processor is further configured to:
generate a prototype of a feature of the software application based on a response to a prompt; and
demonstrate the prototype to the user.

15. A computer readable storage medium having data stored therein representing software executable by a computer, the software comprising instructions that, when executed, cause the computer readable storage medium to perform:
receiving, from a user, a request to generate a software application;
determining a product or service to which the software application is directed;
determining a template for the software application based on the product or service;
generating a machine readable specification for the software application, the machine readable specification having one or more features based on the template.

16. The computer readable storage medium of claim 15, wherein the software instructions further cause the computer readable storage medium to perform determining one or more features for the software application based on the determined product or service.

17. The computer readable storage medium of claim 16, wherein the software instructions further cause the computer readable storage medium to perform generating one or more prompts that are configured to produce a response, from the user, that refines the determined product or service.

18. The computer readable storage medium of claim 17, wherein the software instructions further cause the computer readable storage medium to perform determining one or more features for the software application based on the refined determined product or service.

19. The computer readable storage medium of claim 15, wherein the software instructions further cause the computer readable storage medium to perform:
determining a price to develop the software application; and
transmitting the price to the user.

20. The computer readable storage medium of claim 15, wherein the software instructions further cause the computer readable storage medium to perform:
determining a timeline to develop the software application; and
transmitting the timeline to the user.
